(19) United States
(12) Patent Application Publication
(10) Pub. No.: US 2013/0074454 A1
(43) Pub. Date: Mar. 28, 2013

(54) Polyolefin Films for Packaging and Administering Medical Solutions

(71) Applicant: Robert Babrowicz, Spartanburg, SC (US)

(72) Inventor: Robert Babrowicz, Spartanburg, SC (US)

(73) Assignee: CRYOVAC, INC., Duncan, SC (US)

(21) Appl. No.: 13/245,182

(22) Filed: Sep. 26, 2011

(51) Int. Cl. B65B 1/04; B32B 3/00; B32B 1/08; B32B 27/08

(52) U.S. Cl. 53/467; 428/516; 428/515; 428/220; 428/35.2

(57) ABSTRACT

The presently disclosed subject matter is directed to multilayer films that are suitable for the packaging and administration of medical solutions in the form of flexible pouches. Particularly, the disclosed films comprise two outer layers and a core layer, wherein each layer comprises about 100% by weight polyolefin, based on the total weight of the layer.

### FIELD OF THE INVENTION

The presently disclosed subject matter relates to multilayer films and, more particularly, to multilayer films that are suitable for the packaging and administration of medical solutions in the form of flexible pouches.

### BACKGROUND

Currently, it is common in the medical field to supply medical solutions for parenteral (e.g., intravenous) administration in the form of disposable, flexible pouches. One class of such pouches is commonly referred to as an “I.V. bag.” These pouches must meet a number of performance criteria, including collapsibility, optical clarity and transparency, high-temperature heat-resistance, and sufficient mechanical strength to withstand the rigors of the use environment. Medical solution pouches must also provide a sufficient barrier to the passage of moisture vapor and other gases to prevent contamination of the solution contained therein.

Collapsibility is necessary to ensure proper and complete drainage of the pouch. Unlike rigid liquid containers that rely on air displacement, medical solution pouches rely on collapsibility for drainage. Particularly, as the pouch drains, atmospheric pressure collapses the pouch at a rate that is proportional to the rate of drainage. In this manner, the pouch can be fully drained at a substantially constant rate. To enable collapsibility of the pouch, the film from which the pouch is made must be flexible. If the film is too stiff, the pouch cannot drain fully and the patient may not receive the intended quantity of medical solution. Thus, films used to produce medical solution pouches must have sufficient flexibility such that the resultant medical pouch is collapsible enough to be fully drainable.

Prior to administering a medical solution from a pouch, the medical professional performs a visual inspection of the solution contained within the pouch. Such an inspection provides a cursory determination that the medical solution to be administered is of the proper type and has not deteriorated or become contaminated. In this regard, it is essential that the pouch have excellent optical properties, i.e., a high degree of clarity and transmission and a low degree of haze. A medical solution pouch having poor optical properties can easily render a visual inspection of the packaged solution ineffective, thereby causing the medical professional to needlessly discard the pouch. Worse, the medical professional could fail to notice a solution that is of the wrong type or that had deteriorated or become contaminated. As will be discussed more fully below, the industry-wide practice of heat-sterilizing solution-containing medical pouches greatly exacerbates the problem of maintaining good optical properties in such pouches.

Heat sterilization of solution-containing medical pouches typically occurs in an autoclave at about 250° F. for periods of about 15 to 30 minutes. Such heat sterilization is typically performed by the manufacturer and/or packager of the medical solution prior to shipping to the end user (e.g., a hospital) to help ensure that the medical solution is substantially free from contamination. Accordingly, medical solution pouches must be able to endure the high temperatures that are encountered during heat sterilization without deterioration by developing a heat-seal leak or other type of containment failure.

In addition, medical solution pouches must also have sufficient mechanical strength to withstand the abuse that is typically encountered in the use environment. For example, in some circumstances, a plastic or rubber bladder can be placed around a medical solution-containing pouch and pressurized to, e.g., 300-400 mm/Hg to force the solution out of the pouch an into a patient. Such a bladder is commonly referred to as a “pressure-cuff” and is used, e.g., when a patient is bleeding profusely to quickly replace lost fluids or when a patient has high blood pressure such that a greater opposing pressure must be generated in the pouch to introduce medical solution into the patient's veins. Thus, medical solution pouches should have sufficient durability to remain leak-free during such use procedures.

At present, flexible pouches used for medical solution packaging are generally constructed from a highly plasticized polyvinyl chloride (“PVC”). While generally meeting the requirements mentioned above, PVC can have several undesirable properties when used in a medical solution pouch. For example, plasticizer can migrate from the PVC pouch to contaminate the solution contained therein with a potentially toxic material. It also is questionable whether PVC is adequately chemically neutral to medical solutions. In addition, it has been determined that PVC becomes brittle at relatively low temperatures. Furthermore, disposal of PVC-containing waste can be problematic, as the incineration of PVC generates toxic gases.

For these reasons, alternatives to medical pouches constructed from PVC have been sought. Such alternative pouches are typically formed from polyolefin-containing multilayer films, wherein one exterior layer of the film is an abuse-resistant layer and forms the outside of the pouch, while the other exterior layer of the film is a heat-seal layer and forms the inside of the pouch. A core layer is generally provided as an interior layer in the film to impart strength and flexibility to the film, as well as to contribute to the gas impermeability of the film.

A particularly difficult challenge in the design and manufacture of polyolefin-based films is the ability of the film to provide the above performance criteria after the pouch has been heat-sterilized. Namely, the high temperatures and steam that are encountered during heat-sterilization can adversely affect the collapsibility, mechanical strength, and optical properties of the pouch.

Of particular concern is the adverse effect of heat-sterilization on the optical properties of medical solution pouches. In general, the gas permeability of polyolefin-based films is directly proportional to the temperature of the films. Thus, gas permeability increases with increasing temperature and vice versa. During heat-sterilization, the gas permeability of polyolefin-based medical solution pouches is significantly higher than when such pouches are at room temperature. As a result, the steam that is used to heat the pouches penetrates into the film from which the pouch has been formed. When the sterilization process is completed and the pouch is cooled, steam often condenses and remains trapped inside the film, primarily in the core layer since it is generally the thickest layer of the film. The trapped condensate gives the pouch a hazy, cloudy appearance that can make it difficult to inspect the medical solution contained within the pouch as described above. In addition, the hazy appearance is aesthetically unappealing.

It would also be desirable to produce medical solution pouches formed from a thinner film compared to those currently in use. Particularly, medical solution pouches formed from thinner films have lower package weight and produce less waste. The thinner film can also ensure reduced autoclave time and faster sealing, resulting in improved productivity as more packages can be produced. In addition, films produced from a thinner film results in less mass of materials for extraction, and therefore fewer extractions. Furthermore, a thinner pouch can have an improved aesthetic feel, as well as offer improved ergonomics compared to thicker pouches currently in use.

Accordingly, the presently disclosed subject matter is directed to a polyolefin-based film that is a suitable replacement for PVC as a material for the manufacture of medical solution pouches, and which is also thinner than films currently used in the art.

### SUMMARY

In some embodiments, the presently disclosed subject matter is directed to a multilayer film comprising a first outer layer comprising about 100% by weight polyolefin, based on the total weight of the layer. The film also comprises a core layer comprising about 100% by weight polyolefin, based on the total weight of the layer. The film further comprises a second outer layer comprising about 100% by weight polyolefin, based on the total weight of the layer.

In some embodiments, the presently disclosed subject matter is directed to a pouch for the packaging and administration of a product. In some embodiments, the pouch comprises a multilayer film comprising a first outer layer comprising about 100% by weight polyolefin, based on the total weight of the layer. The film also comprises a core layer comprising about 100% by weight polyolefin, based on the total weight of the layer. The film further comprises a second outer layer comprising about 100% by weight polyolefin, based on the total weight of the layer.

In some embodiments, the presently disclosed subject matter is directed to a method of packaging a product in a pouch, said method comprising providing a pouch comprising a multilayer film comprising a first outer layer comprising about 100% by weight polyolefin, based on the total weight of the layer. The film also comprises a core layer comprising about 100% by weight polyolefin, based on the total weight of the layer. The film further comprises a second outer layer comprising about 100% by weight polyolefin, based on the total weight of the layer. In some embodiments, the method further comprises placing a product into the interior of the pouch and sealing the pouch.

### BRIEF DESCRIPTION OF THE DRAWINGS

FIG. 1 is a schematic cross-section of a 3-layer film in accordance with some embodiments of the presently disclosed subject matter.

FIG. 2 is a schematic cross-section of a 5-layer film in accordance with some embodiments of the presently disclosed subject matter.

FIG. 3 is a schematic cross-section of a 7-layer film in accordance with some embodiments of the presently disclosed subject matter.

FIG. 4 is a schematic cross-section of a 9-layer film in accordance with some embodiments of the presently disclosed subject matter.

### DETAILED DESCRIPTION

### I. General Considerations

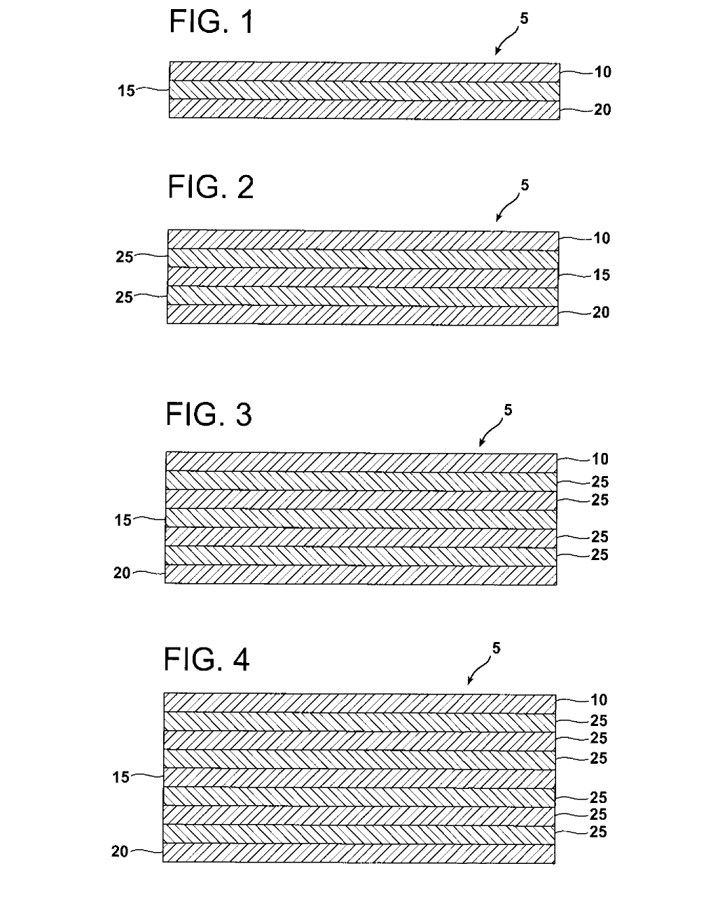

FIG. 1 illustrates multilayer film 5 in accordance some embodiments of the presently disclosed subject matter. In some embodiments, film 5 can be suitable for forming flexible pouches used to house and administer medical solutions. Examples of medical solutions that can be packaged and administered using a pouch constructed from the disclosed film include (but are not limited to) saline solutions, dextrose solutions, and solutions for dialysis applications. However, it is to be understood that other applications for film 5 are also possible, and that the instant disclosure should not be construed as being limited only to medical solution films and pouches.

As set forth in more detail herein below, in some embodiments, film 5 is predominantly disposed of polyolefin materials. In some embodiments, film 5 is constructed from about 100% polyolefin materials. In some embodiments, the structure of film 5 includes a sealant layer based on 100% metallocene polyolefin which is believed to result in a film with lower extractables compared to films currently on the market that typically include polypropylene blended with a rubber modifier. In addition, the disclosed film meets the fit-for-use requirements, including autoclave, oxygen transmission, and moisture vapor transmission barrier, as well as superior sealability and drop test results compared to competitive films on the market today.

### II. Definitions

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long standing patent law convention, the terms “a”, “an”, and “the” refer to “one or more” when used in the subject application, including the claims. Thus, for example, reference to “a film” includes a plurality of such films, and so forth.

Unless indicated otherwise, all numbers expressing quantities of components, reaction conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, percentage, and the like can encompass variations of, and in some embodiments, ±20%, in some embodiments ±10%, in some embodiments ±5%, in some embodiments ±1%, in some embodiments ±0.5%, and in some embodiments ±0.1%, from the specified amount, as such variations are appropriated in the disclosed package and methods. Thus, in some embodiments, the term “about 100%” can refer to exactly 100%, 100%±20%, 100%±10%, 100%±5%, 100%±1%, 100%±0.5%, or 100%±0.1%.

As used herein, the term “adhesive layer” refers to any interior film layer having the primary purpose of adhering two layers to one another.

As used herein, the terms “barrier” and “barrier layer” as applied to films and/or film layers, refer to the ability of a film or film layer to serve as a barrier to gases and/or odors. Examples of polymeric materials with low oxygen transmission rates useful in such a layer can include: ethylene/vinyl alcohol copolymer (EVOH), polyvinylidene dichloride (PVDC), vinylidene chloride copolymer such as vinylidene chloride/methyl acrylate copolymer, vinylidene chloride/vinyl chloride copolymer, polyamide, polyester, polyacrylonitrile (available as Barex™ resin), or blends thereof. Oxygen barrier materials can further comprise high aspect ratio fillers that create a tortuous path for permeation (e.g., nanocomposites). Oxygen barrier properties can be further enhanced by the incorporation of an oxygen scavenger, such as an organic oxygen scavenger. In some embodiments, metal foil, metallized substrates (e.g., metallized polyethylene terephthalate ((PET)), metallized polyamide, and/or metallized polypropylene), and/or coatings comprising SiOx or AlOx compounds can be used to provide low oxygen transmission to a package. In some embodiments, a barrier layer can have a gas (e.g., oxygen) permeability of less than or equal to about 500 cc/m²/24 hrs/atm at 73° F., in some embodiments less than about 100 cc/m²/24 hrs/atm at 73° F., in some embodiments less than about 50 cc/m²/24 hrs/atm at 73° F., and in some embodiments less than about 25 cc/m²/24 hrs/atm at 73° F.

The term “bulk layer” as used herein refers to a layer used to increase the abuse-resistance, toughness, modulus, etc., of a film. In some embodiments, the bulk layer can comprise polyolefin (including but not limited to) at least one member selected from the group comprising ethylene/alpha-olefin copolymer, ethylene/alpha-olefin copolymer plastomer, low density polyethylene, and/or linear low density polyethylene and polyethylene vinyl acetate copolymers.

The term “comprising” as used herein is used synonymously with the term “including” and variations thereof and can be an open, non-limiting term. However, in some embodiments, the term “comprising” can be replaced with “consisting essentially of” or “consisting of”.

The term “copolymer” as used herein refers to a polymer formed by the polymerization reaction of at least two different monomers and is inclusive of random copolymers, block copolymers, graft copolymers, and the like. In some embodiments, the term “copolymer” encompasses terpolymers, quadripolymers, and the like.

The term “core layer” as used herein refers to any inner film layer that can have a function other than serving as an adhesive or compatibilizer for adhering two layers to each other.

The term “cyclic olefin” herein refers to a compound containing a polymerizable carbon-carbon double bond that is either contained within an alicyclic ring (such as, for example, norbornene) or linked to an alicyclic ring (such as, for example, vinyl cyclohexane). Polymerization of the cyclic olefin provides a polymer comprising an alicyclic ring as part of or pendant to the polymer backbone.

The term “cyclic olefin copolymer” and the like herein refers to a copolymer formed by polymerization of a cyclic olefin with a comonomer. One non-limiting example of a cyclic olefin copolymer is ethylene/norbornene copolymer, such as that supplied by Ticona under the trademark TOPAS™, by Zeon under the trademark ZEONOR™ and by Mitsui under the trademark APEL™.

The term “elastomer” as used herein refers to a material that (at room temperature) can be stretched repeatedly to at least twice its original length. Such characteristic distinguishes plastics from elastomers and rubbers, as well as the fact that elastomers are given their final properties by mastication with fillers, processing aids, antioxidants, curing agents, etc., followed by vulcanization (curing) at elevated temperatures. However, a few elastomers are thermoplastic. Such thermoplastic elastomers include (but are not limited to) the following materials: styrene-ethylene-butylene-styrene copolymer (SEBS), styrene-butadiene-styrene copolymer (SBS), styrene-isoprene-styrene copolymer (SIS), ethylene-propylene rubber (EPM), and ethylene-propylene-diene terpolymer (EPDM).

The term “ethylene/alpha-olefin copolymer” (“EAO”) as used herein refers to copolymers of ethylene with one or more comonomers selected from C₃ to C₂₀ alpha-olefins, such as such as 1-butene, 1-pentene, 1-hexene, 1-octene, methyl pentene and the like, in which the polymer molecules comprise long chains with relatively few side chain branches. These polymers are obtained by low pressure polymerization processes and the side branching which is present will be short compared to non-linear polyethylenes (e.g., LDPE, a polyethylene homopolymer). Ethylene/alpha-olefin copolymers generally have a density in the range of from about 0.86 g/cc to about 0.94 g/cc, and can be said to fall into two general categories, heterogeneous and homogeneous, both of which are described below.

As used herein, the term “exterior layer” refers to any layer of a multilayer film having only one of its principal surfaces directly adhered to another layer of the film. In the multilayer films of the presently disclosed subject matter, there are two exterior layers, each of which has a principal surface adhered to only one other layer of the multilayer film. The other principal surface of each of the two exterior layers form the two principal outer surfaces of the multilayer film.

As used herein, the term “film” can be used in a generic sense to include plastic web, regardless of whether it is film or sheet.

As used herein, the term “heterogeneous ethylene/alpha-olefin copolymer” refers to ethylene/alpha-olefin copolymerization reaction products of relatively wide variation in molecular weight and composition distribution, and which are prepared using conventional Ziegler-Natta or other heterogeneous catalysts. As is generally understood, “heterogeneous catalysts” are comprised of several kinds of active sites which differ in Lewis acidity and steric environment. Examples of Ziegler-Natta heterogeneous catalysts include metal halides activated by an organometallic co-catalyst, such as titanium chloride, optionally containing magnesium chloride, complexed to trialkyl aluminum, as is disclosed in patents such as U.S. Pat. Nos. 4,302,565 and 4,302,566, the entire disclosures of which are hereby incorporated by reference. In general, heterogeneous ethylene/alpha-olefins contain a relatively wide variety of chain lengths and comonomer percentages. Examples of heterogeneous ethylene/alpha-olefins include linear low density polyethylene (LLDPE), linear medium density polyethylene (LMDPE), very low density polyethylene (VLDPE), and ultra-low density polyethylene (ULDPE). LLDPE is generally understood to include that group of heterogeneous ethylene/alpha-olefin copolymers which fall into the density range of about 0.915 to about 0.94 g/cc. Linear polyethylene in the density range from about 0.926 to about 0.94 can be referred to as LMDPE. Lower density heterogeneous ethylene/alpha-olefin copolymers are VLDPE (typically used to refer to the ethylene/butene copolymers available from Union Carbide Corporation of Houston, Tex., United States of America with a density ranging from about 0.88 to about 0.91 g/cc) and ULDPE (typically used to refer to the ethylene/octene copolymers supplied by Dow Chemical Company of Midland, Mich., United States of America).

The term “high density polyethylene” refers an ethylene homopolymer or copolymer with a density of 0.940 g/cc or higher.

As used herein, the term “homogeneous ethylene/alpha-olefin copolymer” refers to ethylene/alpha-olefin copolymerization reaction products of relatively narrow molecular weight distribution and relatively narrow composition distribution. Homogeneous ethylene/alpha-olefin copolymers are structurally different from heterogeneous ethylene/alpha-olefin copolymers in that homogeneous ethylene/alpha-olefins exhibit a relatively even sequencing of comonomers within a chain, a mirroring of sequence distribution in all chains, and a similarity of length of all chains, i.e., a narrower molecular weight distribution. Furthermore, homogeneous ethylene/alpha-olefin copolymers are typically prepared using metallocene or other single-site type catalysts, rather than using Ziegler Natta catalysts. Such single-site catalysts typically have only one type of catalytic site, which is believed to be the basis for the homogeneity of the polymers resulting from the polymerization. See, for example, the discussion of homogenous ethylene/alpha-olefin copolymers in U.S. Pat. No. 6,207,776, the entire disclosure of which is hereby incorporated by reference.

The term “instrumented impact” as used herein refers to the energy necessary to puncture a restrained specimen of film, and is measured in accordance with ASTM D-3763.

The term “intermediate layer” as used herein refers to any film layer having both of its principal surfaces directly adhered to another layer of the film.

The term “medical product” as used herein refers to any product that is sterilized prior to use in health care, whether for medical, dental, or veterinary applications, such as those used during medical intervention. Such products can include (but are not limited to) needles, syringes, sutures, wound dressings such as bandages, general wound dressings, non-adherent dressings, burn dressings, surgical tools such as scalpels, gloves, drapes, and other disposal items, solutions, ointments, antibiotics, antiviral agents, blood components such as plasma, drugs, biological agents, intravenous solutions, saline solutions, surgical implants, surgical sutures, stents, catheters, vascular grafts, artificial organs, cannulas, wound care devices, dialysis shunts, wound drain tubes, skin sutures, vascular grafts, implantable meshes, intraocular devices, heart valves, biological graft materials, tape closures and dressings, head coverings, shoe coverings, sterilization wraps, and the like.

The term “moisture vapor transmission rate” as used herein refers to the rate at which water passes through a film structure, and is measured in accordance with ASTM F-1249.

As used herein, the term “olefin” generally refers to any one of a class of monounsaturated, aliphatic hydrocarbons of the general formula CₙH₂ₙ, such as ethylene, propylene, and butene. The term can also include aliphatics containing more than one double bond in the molecule such as a diolefin or diene, e.g., butadiene.

The term “outer layer” as used herein refers to any film layer having less than two of its principal surfaces directly adhered to another layer of the film. A multilayer film has two outer layers, each of which has a principal surface adhered to only one other layer of the multilayer film.

The term “oxygen transmission rate” as used herein refers to the rate of oxygen gas passing through a film structure, and is measured in accordance with ASTM D-3985.

As used herein, the term “polymer” refers to the product of a polymerization reaction, and can be inclusive of homopolymers, copolymers, terpolymers, etc. In some embodiments, the layers of a film can consist essentially of a single polymer, or can have additional polymer together therewith, i.e., blended therewith.

As used herein, the term “polyolefin” refers to olefin polymers and copolymers, especially ethylene and propylene polymers and copolymers, and to polymeric materials having at least one olefinic comonomer, such as ethylene vinyl acetate copolymer and ionomer. Polyolefins can be linear, branched, cyclic, aliphatic, aromatic, substituted, or unsubstituted. Included in the term polyolefin are homopolymers of olefin, copolymers of olefin, copolymers of an olefin and a non-olefinic comonomer copolymerizable with the olefin, such as vinyl monomers, modified polymers of the foregoing, and the like. Modified polyolefins include modified polymers prepared by copolymerizing the homopolymer of the olefin or copolymer thereof with an unsaturated carboxylic acid, e.g., maleic acid, fumaric acid or the like, or a derivative thereof such as the anhydride, ester metal salt or the like. It could also be obtained by incorporating into the olefin homopolymer or copolymer, an unsaturated carboxylic acid, e.g., maleic acid, fumaric acid or the like, or a derivative thereof such as the anhydride, ester metal salt or the like.

The term “polypropylene” refers to a propylene homopolymer or copolymer having greater than 50 mole percent propylene prepared by conventional heterogeneous Ziegler-Natta type initiators or by single site catalysis. Propylene copolymers are typically prepared with ethylene or butene comonomers.

As used herein, the term “pouch” refers to a package that is generally flexible and sealed on at least one side. The term is not limited and can include a wide variety of bags, satchels, and the like.

As used herein, the term “seal” refers to any seal of a first region of an outer film surface to a second region of an outer film surface, including heat or any type of adhesive material, thermal or otherwise. In some embodiments, the seal can be formed by heating the regions to at least their respective seal initiation temperatures. The sealing can be performed by any one or more of a wide variety of means, including (but not limited to) using a heat seal technique (e.g., melt-bead sealing, thermal sealing, impulse sealing, dielectric sealing, radio frequency sealing, ultrasonic sealing, hot air, hot wire, infrared radiation).

As used herein, the phrases “seal layer”, “sealing layer”, “heat seal layer”, and “sealant layer”, refer to an outer film layer, or layers, involved in the sealing of the film to itself, another film layer of the same or another film, and/or another article that is not a film. It should also be recognized that in general, up to the outer 3 mils of a film can be involved in the sealing of the film to itself or another layer. In general, a sealant layer sealed by heat-sealing layer comprises any thermoplastic polymer. In some embodiments, the heat-sealing layer can comprise, for example, thermoplastic polyolefin, thermoplastic polyamide, thermoplastic polyester, and thermoplastic polyvinyl chloride. In some embodiments, the heat-sealing layer can comprise thermoplastic polyolefin.

As used herein, the term “sterilize” or “sterilization” refers to a wide variety of techniques employed to attenuate, kill or eliminate harmful or infectious agents. Examples of sterilization procedures include, for example, gas plasma sterilization, steam sterilization, ozone sterilization, hydrogen peroxide sterilization, ethylene oxide sterilization, and irradiation.

The term “tensile elongation” as used herein refers to the measure of percent elongation to break a film specimen, and is measured in accordance with ASTM D-882.

The term “tensile strength” as used herein refers to the measure of the force required under constant elongation to break a film specimen, and is measured in accordance with ASTM D-882.

As used herein, the term “tie layer” refers to an internal film layer having the primary purpose of adhering two layers to one another. In some embodiments, tie layers can comprise any nonpolar polymer having a polar group grafted thereon, such that the polymer is capable of covalent bonding to polar polymers such as polyamide and ethylene/vinyl alcohol copolymer. In some embodiments, tie layers can comprise at least one member selected from the group including, but not limited to, modified polyolefin, modified ethylene/vinyl acetate copolymer, and/or homogeneous ethylene/alpha-olefin copolymer. In some embodiments, tie layers can comprise at least one member selected from the group consisting of anhydride modified grafted linear low density polyethylene, anhydride grafted low density polyethylene, homogeneous ethylene/alpha-olefin copolymer, and/or anhydride grafted ethylene/vinyl acetate copolymer.

The term “Young's modulus” as used herein refers to an elastic constant that is the ratio of longitudinal stress to longitudinal strain, as measured in accordance with ASTM D-638.

All compositional percentages used herein are presented on a “by weight” basis, unless designated otherwise.

Although the majority of the above definitions are substantially as understood by those of skill in the art, one or more of the above definitions can be defined hereinabove in a manner differing from the meaning as ordinarily understood by those of skill in the art, due to the particular description herein of the presently disclosed subject matter.

### II. The Presently Disclosed Film

Film 5 comprises one or more layers to incorporate a variety of properties, such as sealability, gas impermeability, and toughness into a single film. Thus, in some embodiments, the disclosed film comprises a total of from about 1 to about 20 layers; in some embodiments, from about 3 to about 12 layers; and in some embodiments, from about 5 to about 9 layers. Accordingly, the disclosed film can comprise 1, 2, 3, 4, 5, 6, 7, 8, 9, 10, 11, 12, 13, 14, 15, 16, 17, 18, 19, or 20 layers. One of ordinary skill in the art would also recognize that the disclosed film can comprise more than 20 layers, such as in embodiments wherein the film components comprise microlayering technology.

FIG. 1 illustrates a cross-sectional view of a multilayered film comprising 3 layers. In the embodiment depicted in FIG. 1, film 5 comprises first and second outer layers 10 and 20, both comprising about 100% by weight polyolefin, based on the total weight of the layers. In some embodiments, second outer layer 20 can be a sealant layer comprising about 100% by weight of a metallocene-catalyzed polyolefin material, based on the total weight of the layer. As would be apparent to those having ordinary skill in the art, metallocene-catalyzed polyolefins comprise an ethylene copolymer made using a metallocene catalyst or an equivalent single site metal catalyst. Such copolymers can include (but are not limited to) ethylene, butene, propylene, hexene, or octene copolymers. See, for example, M. Naitove, “Propylenes Will Be The Next Wave of Metallocene-Catalyzed Polyolefins,” Plastics Technology, pp. 19-21 (August 1994), the entire content of which is hereby incorporated by reference.

Film 5 comprises core layer 15 positioned in between the first and second outer layers. In some embodiments, core layer 15 comprises about 100% by weight polyolefin, based on the total weight of the layer.

In some embodiments, film 5 can include at least one intermediate layer positioned between the core layer and an outer layer. The intermediate layer can comprise about 100% by weight polyolefin, based on the total weight of the layer. For example, FIG. 2 illustrates film 5 comprising two intermediate layers 25 positioned between core layer 15 and outer layers 10, 20. In addition, FIGS. 3 and 4 illustrate embodiments of film 5 comprising two and three intermediate layers, respectively, positioned between core layer 15 and outer layers 10, 20. Such intermediate layers can include abuse layers, barrier layers, adhesive layers, and the like, so long as they include about 100% by weight polyolefin materials, based on the total weight of the layer.

It is noted that in some embodiments the Figures are not drawn to scale and layers 10, 15, 20, and 25 can be of varying thicknesses compared to one another.

As can be appreciated by those having ordinary skill in the art, the multilayer films disclosed herein are not limited to the 3-, 5-, 7-, and 9-layer structures described above. Films having a fewer number of layers or a greater number of layers than those shown are also included within the scope of the presently disclosed subject matter.

Polyolefin materials suitable for incorporation into layers 10, 15, 20, and 25 of film 5 can include any polymerized olefin, which can be linear, branched, cyclic, aliphatic, aromatic, substituted, or unsubstituted. Suitable polyolefins can include (but are not limited to) polyethylene homopolymers, polypropylene homopolymers, polybutene homopolymers, ethylene alpha olefin copolymer, propylene alpha olefin copolymer, butene alpha olefin copolymer, ethylene unsaturated ester copolymer, ethylene unsaturated acid copolymer (e.g., ethylene ethyl acrylate copolymer, ethylene butyl acrylate copolymer, ethylene methyl acrylate copolymer, ethylene acrylic acid copolymer, and ethylene methacrylic acid copolymer), ethylene vinyl acetate copolymer, ionomer resin, polymethylpentene, and blends thereof. In some embodiments, suitable polyolefins can include metallocene catalyzed polyolefins.

Specifically, in some embodiments, outer layers 10, 20 can be constructed from materials selected from the group comprising: metallocene polypropylene, ethylene/butene copolymer, ethylene/hexene copolymer, polyethylene homopolymer, modified polypropylene, polypropylene homopolymer, ethylene/norbornene copolymer, polybutene-1, and combinations thereof. For example, in some embodiments, HYBRAR® 7311 (styrene elastomer, available from Kuraray Co., Ltd. of Houston, Tex., United States of America) can be used.

In some embodiments, the materials used to construct core layer 15 can be selected from the group comprising: propylene/ethylene copolymer, ethylene/hexene copolymer, ethylene/octene copolymer, polypropylene homopolymer, polyethylene, reactor or compounded thermoplastic polyolefin or thermoplastic elastomer, propylene/ethylene tripolymers, and combinations thereof.

In some embodiments, the materials used to construct intermediate layer(s) 25 can be selected from the group comprising: ethylene/hexene copolymer, ethylene/octene copolymer, ethylene/butene copolymer, polyethylene homopolymer, polypropylene homopolymer, modified polypropylene (such as thermoplastic polyolefins and thermoplastic elastomers), and combinations thereof.

In some embodiments, various additives can be used in any or all of the layers of film 5. Such additives can include (but are not limited to) anti-blocking agents, antioxidants, processing aids, pigments, antistatic agents, and the like. When the disclosed film is used to construct a medical solution pouch, the amount of such additives included in the film is generally kept to a minimum to minimize the likelihood that such additives will be extracted into the medical solution during heat sterilization.

Film 5 can have a total thickness of about 8 mils or less. Typical thicknesses can range from about 0.1 to 8 mils; in some embodiments, about 0.5 to 7.8 mils; in some embodiments, about 1.0 to 7.5 mils. Thus, in some embodiments, film 5 has a total thickness of about 0.1, 0.5, 1.5, 2.0, 2.5, 3.0, 3.5, 4.0, 4.5, 5.0, 5.5, 6.0, 6.5, 7.0, 7.5, or 8.0 mils.

In some embodiments, film 5 can be transparent (at least in the non-printed regions) such that the packaged product is visible through the film. The term “transparent” as used herein can refer to the ability of a material to transmit incident light with negligible scattering and little absorption, enabling objects (e.g., packaged food or print) to be seen clearly through the material under typical unaided viewing conditions (i.e., the expected use conditions of the material). The transparency of the film can be at least about any of the following values: 20%, 25%, 30%, 40%, 50%, 65%, 70%, 75%, 80%, 85%, and 95%, as measured in accordance with ASTM D1746.

In some embodiments, film 5 can comprise printed product information such as (but not limited to) product size, type, name of manufacturer, and the like. Such printing methods are well known to those of ordinary skill in the packaging art.

### III. Methods of Making the Disclosed Film

In some embodiments, film 5 can be formed by cast coextrusion as a tubular film. Pouches for medical applications or other end uses can be formed directly from the coextruded, tubular film, or alternatively from rollstock material obtained from the tube after it has been slit and ply-separated. A hot blown process can also be used to construct film 5, although the optical properties of the resulting pouch would likely be inferior to those from a cast coextrusion process. Other processes, such as extrusion coating, conventional lamination, slot die extrusion, etc., can also be used to construct film 5.

In some embodiments, film 5 can be cross-linked. Cross-linking increases the structural strength of the film at elevated temperatures and/or increases the force at which the material can be stretched before tearing apart, and can also improve the optical properties of the film. Cross-linking can be achieved using irradiation, i.e., bombarding the film with particulate or non-particulate radiation (such as high-energy electrons from an accelerator or cobalt-60 gamma rays) to cross-link the materials of the film. In some embodiments, the irradiation dosage level can be in the range of from about 2 to about 8 megarads. Any conventional cross-linking technique can be used, such as (but not limited to) curtain-beam irradiation. Chemical cross-linking techniques can also be employed, such as the use of peroxides.

### IV. Methods of Using the Disclosed Film

Pouches constructed from the disclosed film can be sealed using various means well known in the art, including (but not limited to) impulse and hot-bar sealing. One example of a commercially available impulse-type sealing device is a Vertrod™ heat sealer. The heat seals that form the top and bottom of the pouch (generally shorter in length than the sides of the pouch) can be formed in the machine direction of the film (i.e., the direction in which the film moved through the production equipment) verses the transverse direction (perpendicular to the machine direction). Alternatively or in addition, in some embodiments, typical converting equipment can be used (such as a Plumat line, available from Plumat North America, Naperville, Ill., United States of America), which utilizes a standard hot bar perimeter seal.

When film 5 is formed into a medical solution pouch, outer layer 10 can be a heat/abuse-resistant layer that forms the outside surface of the pouch. The primary functions of the heat/abuse-resistant layer are to provide heat-resistance to the pouch during heat-sealing and heat-sterilization and to provide abuse-resistance from external handling and abrasion. As set forth above, layer 10 comprises about 100% by weight polyolefin, based on the total weight of the layer.

The presently disclosed film has been described in connection with a pouch for the packaging of medical solutions. However, it is to be understood that other embodiments of the disclosed film are also envisioned. For example, film 5 can be used as an overwrap film to protect bags or other packages from dust and to provide an additional moisture barrier. In some embodiments, film 5 can be used as a lidstock for, e.g., polypropylene trays. As can be appreciated, other applications for film 5 are also possible, such as food retort applications (pending FDA compliance).

### V. Advantages of the Disclosed Film

As set forth herein above, film 5 can be formed into a medical solution pouch. In these embodiments, second outer layer 20 (the heat seal layer) can form the inside surface of the pouch, i.e., the surface that is in contact with the packaged medical solution. The primary function of second outer layer 20 is to form a heat seal when film 5 is folded upon itself or mated with another film such that two regions of layer 20 are brought into contact with one another and sufficient heat is applied to predetermined segments of the contacting regions of layer 20 that the heated segments become molten and intermix with one another. Upon cooling, the heated segments of second outer layer 20 become a single, essentially inseparable layer. In this manner, the heated segments of layer 20 produce a liquid-tight closure that is commonly referred to as a heat seal. The heat seals thus formed in some embodiments can be generally fin-shaped and can be linked together to define the peripheral boundaries of the pouch so that a medical solution can be fully enclosed therein.

The material from which the heat-seal layer is formed must be able to maintain a liquid-tight heat-seal in a wide variety of severe conditions that are typically encountered by a medical solution pouch. During heat-sterilization, for example, medical solution pouches are exposed to high temperatures (e.g., 250° F.) for periods of 15 to 30 minutes. Thus, the film material must have sufficient heat-resistance to maintain a seal under such conditions. In addition, the heat seal material must have sufficient creep-resistance to maintain a heat seal when the pouch is placed in a pressure-cuff. Without sufficient creep-resistance, the relatively high fluid pressure of the medical solution inside the pouch forces the heat seal apart. Additionally, the heat seal material must have sufficient impact-resistance to maintain a seal when the solution-containing pouch is dropped or otherwise handled roughly.

The foregoing criteria are satisfied by layer 20 of the disclosed film, which comprises about 100% by weight polyolefin. In some embodiments, the layer is constructed from about 100% metallocene-catalyzed polyolefin materials. Such heat seals are consistently able to withstand all of the aforementioned severe conditions typically encountered by medical solution pouches, i.e., heat-sterilization, pressure-cuff application, and general rough handling.

Film 5 exhibits a tensile elongation at yield that ranges from about 10% to about 30%; in some embodiments, from about 10% to about 25%; and in some embodiments from about 10% to about 20% (ASTM D-882). Thus, the disclosed films can have a tensile elongation at break of at least about (or at most about): 10, 11, 12, 13, 14, 15, 16, 17, 18, 19, 20, 21, 22, 23, 24, 25, 26, 27, 28, 29, or 30%. It should also be appreciated that films that do not exhibit a yield point can also be included within the scope of the presently disclosed subject matter.

Film 5 exhibits a tensile elongation at break that ranges from about 400% to about 900%; in some embodiments, from about 450% to about 800%; and in some embodiments from about 500% to about 700% (ASTM D-882). Thus, in some embodiments, film 5 has a tensile elongation at break of at least (or at most) about: 450, 475, 500, 525, 550, 575, 600, 625, 650, 675, 700, 725, 750, 775, or 800%.

Film 5 exhibits a Young's modulus sufficient to withstand the expected handling and use conditions. To this end, the disclosed film can have a Young's modulus in the range of about 15,000 psi to about 70,000 psi; in some embodiments, from about 20,000 psi to about 65,000 psi; in some embodiments, and in some embodiments, from about 25,000 psi to about 55,000 psi (ASTM D-638). Thus, in some embodiments, the disclosed films can have a Young's modulus of at least about (or at most about): 15,000; 20,000; 25,000; 30,000; 35,000; 40,000; 45,000; 50,000; 55,000; 60,000; 65,000; or 70,000 psi. Film 5 can have any of the foregoing ranges of Young's modulus in at least one direction (e.g., in the machine direction or in the transverse direction) or in both directions (e.g., both the machine direction and the transverse direction).

Film 5 can have a moisture vapor transmission rate in the range of about 0.01 to about 0.5 g/100 in²-day; in some embodiments, from about 0.05 to about 0.4 g/100 in²-day; and in some embodiments, from about 0.1 to about 0.3 g/100 in²-day (ASTM F-1249). Thus, in some embodiments, the disclosed films can have a moisture vapor transmission rate of at least about (or at most about): 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, and 0.30 g/100 in²-day.

The disclosed film can have an oxygen transmission rate in the range of about 500 to about 5000 cc/m²-day-atm; in some embodiments, from about 700 to about 4000 cc/m²-day-atm; and in some embodiments, from about 900 to about 3000 cc/m²-day-atm (ASTM D-3985). Thus, in some embodiments, the disclosed films can have an oxygen transmission rate of at least about (or at most about): 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, or 4000 cc/m²-day-atm. In some embodiments, the disclosed films can have an oxygen transmission rate of less than 1200 cc/m²-day-atm.

In some embodiments, the disclosed films can have an instrumented impact in the range of about 1.0 to about 7.5 J/mil; in some embodiments, from about 1.0 to about 7.0 J/mil; and in some embodiments, from about 1.0 to about 6.5 J/mil (ASTM D-3763). Thus, in some embodiments, the disclosed films have an instrumented impact of at least about (or at most about) 1.0, 1.5, 2.0, 2.5, 3.0, 3.5, 4.0, 4.5, 5.0, 5.5, 6.0, 6.5, 7.0, or 7.5 J/mil.

When used to form medical solution pouches, the disclosed films have been found to possess excellent optical properties (i.e., transmission, clarity, and haze) both before and after sterilization (such as, for example, standard autoclave conditions).

In addition, the disclosed films exhibit all of the other performance criteria that are required in a medical solution pouch. That is, the films have good flexibility/collapsibility and mechanical strength, and are able to withstand high-temperature sterilization. In addition, the films provide good barrier properties. For these reasons, the inventive multilayer films are particularly suited for the packaging and administration of medical solutions.

### EXAMPLES

The following Examples provide illustrative embodiments. In light of the present disclosure and the general level of skill in the art, those of ordinary skill in the packaging art will appreciate that the following Examples are intended to be exemplary only and that numerous changes, modifications, and alterations can be employed without departing from the scope of the presently disclosed subject matter.

Several film structures are identified herein below in Tables 1 and 2.

TABLE 1
Resin Identification

| Material | Trade Name or | |
|---|---|---|
| Code | Designation | Source |
| A | Wintec WFW4F | Japan Polypropylene |
| | | Corporation (Tokyo, |
| | | Japan) |
| B | EXACT 3128 | ExxonMobile (Fairfax, |
| | | Virginia, United States of |
| | | America) |
| C | Exxon PP9122 | ExxonMobile (Fairfax, |
| | | Virginia, United States of |
| | | America) |
| D | Exxon PP1024 | ExxonMobile (Fairfax, |
| | | Virginia, United States of |
| | | America) |
| E | Zylar 631 | Nova Chemicals (Moon |
| | | Township, Pennsylvania, |
| | | United States of America) |
| F | XUS 61520.15L | Dow Chemical Company |
| | | (Midland, Michigan, |
| | | United States of America) |
| G | CV77525 | Westlake Chemical |
| | | Corporation (Houston, |
| | | Texas, United States of |
| | | America) |
| H | EXCEED 1012CA | ExxonMobile (Fairfax, |
| | | Virginia, United States of |
| | | America) |
| I | AFFINITY PL 1840G | Dow Chemical Company |
| | | (Midland, Michigan, |
| | | United States of America) |
| J | DS6D81 | Dow Chemical Company |
| | | (Midland, Michigan, |
| | | United States of America) |
| K | Exceed 1012CJ | ExxonMobile (Fairfax, |
| | | Virginia, United States of |
| | | America) |
| L | SURPASS HPs167-AB | Nova Chemicals (Moon |
| | | Township, Pennsylvania, |
| | | United States of America) |
| M | Welnex RFXHV | Japan Polypropylene |
| | | Corporation (Tokyo, |
| | | Japan) |
| N | Hyperform Concentrate | Milliken Corporation |
| | HL3-4 | (Spartanburg, South |
| | | Carolina, United States of |
| | | America) |
| O | Millad Concentrate NX- | Milliken Corporation |
| | 20 | (Spartanburg, South |
| | | Carolina, United States of |
| | | America) |
| P | Dow PP H-700-12 | Dow Chemical Company |
| | | (Midland, Michigan, |
| | | United States of America) |
| Q | Topas 8007 F-04 | Topas Advanced |
| | | Polymers, Inc. (Florence, |
| | | Kentucky, United States |
| | | of America) |
| R | ELITE 5940 | Dow Chemical Company |
| | | (Midland, Michigan, |
| | | United States of America) |
| S | PB 0300 | LyondellBasell Industries |
| | | (Rotterdam, Netherlands) |
| T | Petrothene NA 345-013 | LyondellBasell Industries |
| | | (Rotterdam, Netherlands) |
| U | HYBRAR ® 7311 | Kuraray Co., Ltd. |
| | | (Houston, Texas, United |
| | | States of America) |
| V | T60-500-119 | Ineos Barex (Delaware |
| | | City, Delaware, United |
| | | States of America) |
| W | LL 3003.32 | ExxonMobile (Fairfax, |
| | | Virginia, United States of |
| | | America) |
| X | ESCORENE LD-200.48 | ExxonMobile (Fairfax, |
| | | Virginia, United States of |
| | | America) |
| Y | KRATON G1645 | Kraton Polymers US |
| | | (Houston, Texas, United |
| | | States of America) |
| Z | MD590 | Teknor Apex Co. |
| | | (Pawtucket, Rhode |
| | | Island, United States of |
| | | America) |

A is a metallocene polypropylene/ethylene copolymer.
B is a very low density ethylene/butene copolymer with density of 0.900 g/cc and melting point of 92° C.
C is a propylene/ethylene copolymer with flow rate of 1.8-2.3 grams/10 minutes, density of 0.900 g/cc at 23° C., and random ethylene content (wt %) of 2.0-2.3%.
D is a polypropylene homopolymer.
E is a styrene methylmethacrylate copolymer.
F is a very low density ethylene/octene copolymer with density of 0.903 g/cc (+/−0.002), DSC melting temperature of 123° C., and (wt percent) octene of 11.5% (+/−1.0).
G is a very low density ethylene/hexene copolymer.
H is a very low density ethylene/hexene copolymer with melt flow index of 0.8-1.2 and density of 0.909-0.913 g/cc.
I is a very low density ethylene/octene copolymer.
J is a propylene/ethylene copolymer with flow rate of 6.0-9.0 g/10 min. and density of 0.900 g/cc (+/−0.005).
K is a very low density ethylene/hexene copolymer with density of 0.910-0.914 g/cc and melt flow rate of 0.8-1.2 g/10 minutes.
L is high density polyethylene homopolymer.
M is a modified polypropylene.
N is a polyolefin nucleating masterbatch.
O is a polypropylene clarifying masterbatch.
P is a polypropylene homopolymer.
Q is an ethylene/norbornene copolymer with flow rate of 22-42 g/10 minutes at 260° C., Tg of 78° C. (+/−4° C.), comonomer content of 36%, and density of 1.02 g/cc.
R is a medium density polyethylene.
S is polybutene-1.
T is low density polyethylene homopolymers with flow rate of 1.5-2.1 g/10 minutes, density of 0.918-0.924 g/cc at 23° C., and DSC melting point of 112° C.
U is a styrene elastomer.
V is high density polyethylene with density of 0.961 g/cc (at 23° C.) and vicat softening point of 133° C.
W is linear low density polyethylene with melt index of 2.9-3.5 g/10 minutes, melting point of 124° C., and density of 0.916-0.919 g/cc.
X is low density polyethylene with density of 0.914-0.916 g/cc (at 23° C.) and DSC melting temperature of 104° C.
Y is a linear triblock copolymer based on styrene and ethylene/butylene.
Z is a thermoplastic elastomer with specific gravity of 0.890.

TABLE 2
Film Identification

| Film ID | Layer | Formulation | | Volume % | Mils |
|---|---|---|---|---|---|
| Film 1 | 1 | 56% | A | 9.8 | 0.6 |
| | | 44% | B | | |
| | 2 | 100% | B | 14.0 | 0.85 |
| | 3 | 100% | B | 14.0 | 0.85 |
| | 4 | 100% | C | 24.9 | 1.52 |
| | 5 | 100% | B | 13.7 | 0.84 |
| | 6 | 100% | B | 13.7 | 0.84 |
| | 7 | 100% | D | 10.0 | 0.61 |
| Film 2 | 1 | 56% | A | 9.6 | 0.56 |
| | | 44% | B | | |
| | 2 | 100% | B | 14.6 | 0.85 |
| | 3 | 100% | B | 14.6 | 0.85 |
| | 4 | 100% | C | 26.0 | 1.51 |
| | 5 | 100% | B | 14.4 | 0.84 |
| | 6 | 100% | B | 14.4 | 0.84 |
| | 7 | 100% | E | 6.0 | 0.35 |
| Film 3 | 1 | 56% | A | 10.0 | 0.60 |
| | | 44% | B | | |
| | 2 | 100% | F | 13.8 | 0.83 |
| | 3 | 100% | F | 13.8 | 0.83 |
| | 4 | 100% | C | 25.0 | 1.50 |
| | 5 | 100% | F | 13.8 | 0.83 |
| | 6 | 100% | F | 13.8 | 0.83 |
| | 7 | 100% | D | 10.0 | 0.60 |
| Film 4 | 1 | 56% | A | 10.0 | 0.60 |
| | | 44% | B | | |
| | 2 | 100% | G | 13.8 | 0.83 |
| | 3 | 100% | G | 13.8 | 0.83 |
| | 4 | 100% | C | 25.0 | 1.50 |
| | 5 | 100% | G | 13.8 | 0.83 |
| | 6 | 100% | G | 13.8 | 0.83 |
| | 7 | 100% | D | 10.0 | 0.60 |
| Film 5 | 1 | 56% | A | 10.0 | 0.60 |
| | | 44% | B | | |
| | 2 | 100% | H | 13.8 | 0.83 |
| | 3 | 100% | H | 13.8 | 0.83 |
| | 4 | 100% | C | 25.0 | 1.50 |
| | 5 | 100% | H | 13.8 | 0.83 |
| | 6 | 100% | H | 13.8 | 0.83 |
| | 7 | 100% | D | 10.0 | 0.60 |
| Film 6 | 1 | 56% | A | 10.0 | 0.60 |
| | | 44% | B | | |
| | 2 | 100% | I | 13.8 | 0.83 |
| | 3 | 100% | I | 13.8 | 0.83 |
| | 4 | 100% | C | 25.0 | 1.50 |
| | 5 | 100% | I | 13.8 | 0.83 |
| | 6 | 100% | I | 13.8 | 0.83 |
| | 7 | 100% | D | 10.0 | 0.60 |
| Film 7 | 1 | 56% | A | 10.0 | 0.60 |
| | | 44% | B | | |
| | 2 | 100% | B | 13.8 | 0.83 |
| | 3 | 100% | B | 13.8 | 0.83 |
| | 4 | 100% | J | 25.0 | 1.50 |
| | 5 | 100% | B | 13.8 | 0.83 |
| | 6 | 100% | B | 13.8 | 0.83 |
| | 7 | 100% | D | 10.0 | 0.60 |
| Film 8 | 1 | 56% | A | 11.7 | 0.71 |
| | | 44% | B | | |
| | 2 | 100% | K | 17.3 | 1.05 |
| | 3 | 75% | L | 7.6 | 0.46 |
| | | 25% | K | | |
| | 4 | 100% | K | 7.1 | 0.43 |
| | 5 | 75% | L | 8.7 | 0.53 |
| | | 25% | K | | |
| | 6 | 100% | K | 8.7 | 0.53 |
| | 7 | 75% | L | 9.6 | 0.58 |
| | | 25% | K | | |
| | 8 | 100% | K | 16.0 | 0.97 |
| | 9 | 100% | M | 13.4 | 0.81 |
| Film 9 | 1 | 56% | A | 11.1 | 0.68 |
| | | 44% | B | | |
| | 2 | 98% | K | 16.2 | 0.99 |
| | | 2% | N | | |
| | 3 | 75% | L | 6.9 | 0.42 |
| | | 23% | K | | |
| | | 2% | N | | |
| | 4 | 98% | K | 6.9 | 0.42 |
| | | 2% | N | | |
| | 5 | 75% | L | 9.1 | 0.56 |
| | | 23% | K | | |
| | | 2% | N | | |
| | 6 | 98% | K | 9.6 | 0.59 |
| | | 2% | N | | |
| | 7 | 75% | L | 9.6 | 0.59 |
| | | 23% | K | | |
| | | 2% | N | | |
| | 8 | 98% | K | 17.0 | 1.04 |
| | | 2% | N | | |
| | 9 | 98% | M | 13.7 | 0.84 |
| | | 2% | O | | |
| Film 10 | 1 | 56% | A | 11.7 | 0.70 |
| | | 44% | B | | |
| | 2 | 100% | F | 16.7 | 1.00 |
| | 3 | 75% | L | 8.3 | 0.50 |
| | | 25% | H | | |
| | 4 | 100% | F | 8.3 | 0.50 |
| | 5 | 75% | L | 8.3 | 0.50 |
| | | 25% | H | | |
| | 6 | 100% | F | 8.3 | 0.50 |
| | 7 | 75% | L | 8.3 | 0.50 |
| | | 25% | H | | |
| | 8 | 100% | F | 16.7 | 1.00 |
| | 9 | 100% | M | 13.3 | 0.80 |
| Film 11 | 1 | 56% | A | 11.7 | 0.70 |
| | | 44% | B | | |
| | 2 | 98% | F | 16.7 | 1.00 |
| | | 2% | N | | |
| | 3 | 75% | L | 8.3 | 0.50 |
| | | 23% | F | | |
| | | 2% | N | | |
| | 4 | 98% | F | 8.3 | 0.50 |
| | | 2% | N | | |
| | 5 | 75% | L | 8.3 | 0.50 |
| | | 23% | F | | |
| | | 2% | N | | |
| | 6 | 98% | F | 8.3 | 0.50 |
| | | 2% | N | | |
| | 7 | 75% | L | 8.3 | 0.50 |
| | | 23% | F | | |
| | | 2% | N | | |
| | 8 | 98% | F | 16.7 | 1.00 |
| | | 2% | N | | |
| | 9 | 98% | M | 13.3 | 0.80 |
| | | 2% | O | | |
| Film 12 | 1 | 56% | A | 11.7 | 0.71 |
| | | 44% | B | | |
| | 2 | 100% | K | 17.3 | 1.05 |
| | 3 | 75% | L | 7.6 | 0.46 |
| | | 25% | K | | |
| | 4 | 100% | K | 7.1 | 0.43 |
| | 5 | 75% | L | 8.7 | 0.53 |
| | | 25% | K | | |
| | 6 | 100% | K | 8.7 | 0.53 |
| | 7 | 75% | L | 9.6 | 0.58 |
| | | 25% | K | | |
| | 8 | 100% | K | 16.0 | 0.97 |
| | 9 | 100% | M | 13.4 | 0.81 |
| Film 13 | 1 | 56% | A | 11.9 | 0.71 |
| | | 44% | B | | |
| | 2 | 100% | F | 12.5 | 0.73 |
| | 3 | 70% | P | 8.9 | 0.53 |
| | | 30% | K | | |
| | 4 | 100% | K | 7.0 | 0.42 |
| | 5 | 70% | P | 11.6 | 0.69 |
| | | 30% | K | | |
| | 6 | 100% | K | 10.1 | 0.60 |
| | 7 | 70% | P | 13.6 | 0.81 |
| | | 30% | K | | |
| | 8 | 100% | F | 11.7 | 0.70 |
| | 9 | 100% | M | 13.2 | 0.79 |
| Film 14 | 1 | 56% | A | 11.7 | 0.70 |
| | | 44% | B | | |
| | 2 | 100% | K | 16.7 | 1.00 |
| | 3 | 70% | P | 8.3 | 0.50 |
| | | 26% | L | | |
| | | 2% | O | | |
| | | 2% | N | | |
| | 4 | 100% | K | 8.3 | 0.50 |
| | 5 | 70% | P | 8.3 | 0.50 |
| | | 26% | L | | |
| | | 2% | O | | |
| | | 2% | N | | |
| | 6 | 100% | K | 8.3 | 0.50 |
| | 7 | 70% | P | 8.3 | 0.50 |
| | | 26% | L | | |
| | | 2% | O | | |
| | | 2% | N | | |
| | 8 | 100% | K | 16.7 | 1.00 |
| | 9 | 98% | M | 13.3 | 0.80 |
| | | 2% | O | | |
| Film 15 | 1 | 56% | A | 11.7 | 0.70 |
| | | 44% | B | | |
| | 2 | 100% | F | 16.7 | 1.00 |
| | 3 | 70% | P | 8.3 | 0.50 |
| | | 30% | K | | |
| | 4 | 100% | K | 8.3 | 0.50 |
| | 5 | 70% | P | 8.3 | 0.50 |
| | | 30% | K | | |
| | 6 | 100% | K | 8.3 | 0.50 |
| | 7 | 70% | P | 8.3 | 0.50 |
| | | 30% | K | | |
| | 8 | 100% | F | 16.7 | 1.00 |
| | 9 | 77.5% | M | 13.3 | 0.80 |
| | | 20.5% | P | | |
| | | 2% | O | | |
| Film 16 | 1 | 56% | A | 16.6 | 0.98 |
| | | 44% | B | | |
| | 2 | 100% | B | 12.0 | 0.71 |
| | 3 | 75% | L | 8.5 | 0.50 |
| | | 25% | H | | |
| | 4 | 100% | B | 9.1 | 0.54 |
| | 5 | 75% | L | 8.1 | 0.48 |
| | | 25% | H | | |
| | 6 | 100% | B | 9.1 | 0.54 |
| | 7 | 75% | L | 9.1 | 0.54 |
| | | 25% | H | | |
| | 8 | 100% | B | 12.0 | 0.71 |
| | 9 | 100% | P | 16.0 | 0.94 |
| Film 17 | 1 | 56% | A | 16.7 | 1.00 |
| | | 44% | B | | |
| | 2 | 100% | B | 12.5 | 0.75 |
| | 3 | 75% | L | 8.4 | 0.50 |
| | | 25% | H | | |
| | 4 | 100% | B | 8.3 | 0.50 |
| | 5 | 75% | L | 8.3 | 0.50 |
| | | 25% | H | | |
| | 6 | 100% | B | 8.3 | 0.50 |
| | 7 | 75% | L | 8.3 | 0.50 |
| | | 25% | H | | |
| | 8 | 100% | B | 12.5 | 0.75 |
| | 9 | 60% | P | 16.7 | 1.00 |
| | | 40% | M | | |
| Film 18 | 1 | 56% | A | 16.7 | 1.00 |
| | | 44% | B | | |
| | 2 | 100% | B | 12.5 | 0.75 |
| | 3 | 75% | L | 8.4 | 0.50 |
| | | 25% | H | | |
| | 4 | 100% | B | 8.3 | 0.50 |
| | 5 | 75% | L | 8.3 | 0.50 |
| | | 25% | H | | |
| | 6 | 100% | B | 8.3 | 0.50 |
| | 7 | 75% | L | 8.3 | 0.50 |
| | | 25% | H | | |
| | 8 | 100% | B | 12.5 | 0.75 |
| | 9 | 70% | P | 16.7 | 1.00 |
| | | 30% | H | | |
| Film 19 | 1 | 56% | A | 16.7 | 1.00 |
| | | 44% | B | | |
| | 2 | 100% | B | 12.5 | 0.75 |
| | 3 | 75% | L | 8.4 | 0.50 |
| | | 25% | H | | |
| | 4 | 100% | B | 8.3 | 0.50 |
| | 5 | 75% | L | 8.3 | 0.50 |
| | | 25% | H | | |
| | 6 | 100% | B | 8.3 | 0.50 |
| | 7 | 75% | L | 8.3 | 0.50 |
| | | 25% | H | | |
| | 8 | 100% | B | 12.5 | 0.75 |
| | 9 | 70% | L | 16.7 | 1.00 |
| | | 30% | K | | |
| Film 20 | 1 | 56% | A | 16.7 | 1.00 |
| | | 44% | B | | |
| | 2 | 100% | B | 12.5 | 0.75 |
| | 3 | 75% | L | 8.4 | 0.50 |
| | | 25% | H | | |
| | 4 | 100% | B | 8.3 | 0.50 |
| | 5 | 75% | L | 8.3 | 0.50 |
| | | 25% | H | | |
| | 6 | 100% | B | 8.3 | 0.50 |
| | 7 | 75% | L | 8.3 | 0.50 |
| | | 25% | H | | |
| | 8 | 100% | B | 12.5 | 0.75 |
| | 9 | 70% | K | 16.7 | 1.00 |
| | | 30% | Q | | |
| Film 21 | 1 | 56% | A | 14.1 | 0.81 |
| | | 44% | B | | |
| | 2 | 100% | B | 15.4 | 0.89 |
| | 3 | 70% | P | 9.0 | 0.52 |
| | | 30% | H | | |
| | 4 | 100% | B | 8.0 | 0.46 |
| | 5 | 70% | P | 8.0 | 0.46 |
| | | 30% | H | | |
| | 6 | 100% | B | 8.3 | 0.48 |
| | 7 | 70% | P | 7.5 | 0.43 |
| | | 30% | H | | |
| | 8 | 100% | B | 16.5 | 0.95 |
| | 9 | 60% | P | 13.2 | 0.76 |
| | | 40% | M | | |
| Film 22 | 1 | 56% | A | 16.7 | 1.00 |
| | | 44% | B | | |
| | 2 | 100% | B | 12.5 | 0.75 |
| | 3 | 75% | R | 8.4 | 0.50 |
| | | 25% | H | | |
| | 4 | 100% | B | 8.3 | 0.50 |
| | 5 | 75% | R | 8.3 | 0.50 |
| | | 25% | H | | |
| | 6 | 100% | B | 8.3 | 0.50 |
| | 7 | 75% | R | 8.3 | 0.50 |
| | | 25% | H | | |
| | 8 | 100% | B | 12.5 | 0.75 |
| | 9 | 100% | P | 16.7 | 1.00 |
| Film 23 | 1 | 56% | A | 11.8 | 0.72 |
| | | 44% | B | | |
| | 2 | 100% | F | 20.3 | 1.24 |
| | 3 | 70% | P | 7.2 | 0.44 |
| | | 30% | K | | |
| | 4 | 70% | P | 7.2 | 0.44 |
| | | 30% | K | | |
| | 5 | 70% | P | 7.2 | 0.44 |
| | | 30% | K | | |
| | 6 | 70% | P | 7.2 | 0.44 |
| | | 30% | K | | |
| | 7 | 70% | P | 7.2 | 0.44 |
| | | 30% | K | | |
| | 8 | 100% | F | 20.7 | 1.26 |
| | 9 | 100% | M | 11.6 | 0.71 |
| Film 24 | 1 | 56% | A | 11.8 | 0.72 |
| | | 44% | B | | |
| | 2 | 100% | K | 20.1 | 1.22 |
| | 3 | 70% | P | 7.1 | 0.43 |
| | | 30% | K | | |
| | 4 | 70% | P | 7.1 | 0.43 |
| | | 30% | K | | |
| | 5 | 70% | P | 7.1 | 0.43 |
| | | 30% | K | | |
| | 6 | 70% | P | 7.1 | 0.43 |
| | | 30% | K | | |
| | 7 | 70% | P | 7.1 | 0.43 |
| | | 30% | K | | |
| | 8 | 100% | K | 21.1 | 1.28 |
| | 9 | 100% | M | 11.5 | 0.70 |
| Film 25 | 1 | 56% | A | 11.7 | 0.70 |
| | | 44% | K | | |
| | 2 | 100% | F | 20.8 | 1.25 |
| | 3 | 70% | P | 7.0 | 0.42 |
| | | 30% | K | | |
| | 4 | 70% | P | 7.0 | 0.42 |
| | | 30% | K | | |
| | 5 | 70% | P | 7.0 | 0.42 |
| | | 30% | K | | |
| | 6 | 70% | P | 7.0 | 0.42 |
| | | 30% | K | | |
| | 7 | 70% | P | 7.0 | 0.42 |
| | | 30% | K | | |
| | 8 | 100% | F | 20.8 | 1.25 |
| | 9 | 100% | M | 11.7 | 0.70 |
| Film 26 | 1 | 65% | A | 11.7 | 0.70 |
| | | 35% | S | | |
| | 2 | 100% | F | 20.8 | 1.25 |
| | 3 | 70% | P | 7.0 | 0.42 |
| | | 30% | K | | |
| | 4 | 70% | P | 7.0 | 0.42 |
| | | 30% | K | | |
| | 5 | 70% | P | 7.0 | 0.42 |
| | | 30% | K | | |
| | 6 | 70% | P | 7.0 | 0.42 |
| | | 30% | K | | |
| | 7 | 70% | P | 7.0 | 0.42 |
| | | 30% | K | | |
| | 8 | 100% | F | 20.8 | 1.25 |
| | 9 | 100% | M | 11.7 | 0.70 |
| Film 27 | 1 | 56% | A | 11.7 | 0.70 |
| | | 44% | B | | |
| | 2 | 100% | F | 20.8 | 1.25 |
| | 3 | 70% | P | 7.0 | 0.42 |
| | | 30% | K | | |
| | 4 | 70% | P | 7.0 | 0.42 |
| | | 30% | K | | |
| | 5 | 70% | P | 7.0 | 0.42 |
| | | 30% | K | | |
| | 6 | 70% | P | 7.0 | 0.42 |
| | | 30% | K | | |
| | 7 | 70% | P | 7.0 | 0.42 |
| | | 30% | K | | |
| | 8 | 100% | F | 20.8 | 1.25 |
| | 9 | 70% | P | 11.7 | 0.70 |
| | | 30% | S | | |
| Film 28 | 1 | 56% | A | 11.1 | 0.69 |
| | | 44% | B | | |
| | 2 | 100% | F | 13.9 | 0.86 |
| | 3 | 70% | P | 8.4 | 0.52 |
| | | 30% | K | | |
| | 4 | 100% | K | 7.6 | 0.47 |
| | 5 | 70% | P | 8.9 | 0.55 |
| | | 30% | K | | |
| | 6 | 100% | K | 9.7 | 0.60 |
| | 7 | 70% | P | 14.5 | 0.90 |
| | | 30% | K | | |
| | 8 | 100% | F | 14.2 | 0.88 |
| | 9 | 100% | M | 11.8 | 0.73 |
| Film 29 | 1 | 56% | A | 12.1 | 0.72 |
| | | 44% | B | | |
| | 2 | 100% | F | 12.0 | 0.71 |
| | 3 | 70% | P | 8.6 | 0.51 |
| | | 30% | K | | |
| | 4 | 100% | T | 7.2 | 0.43 |
| | 5 | 70% | P | 11.4 | 0.68 |
| | | 30% | K | | |
| | 6 | 100% | T | 10.4 | 0.62 |
| | 7 | 70% | P | 13.8 | 0.82 |
| | | 30% | K | | |
| | 8 | 100% | F | 12.6 | 0.75 |
| | 9 | 100% | M | 12.1 | 0.72 |
| Film 30 | 1 | 56% | A | 11.7 | 0.70 |
| | | 44% | B | | |
| | 2 | 98% | K | 16.7 | 1.0 |
| | | 2% | N | | |
| | 3 | 75% | L | 8.3 | 0.5 |
| | | 23% | K | | |
| | | 2% | N | | |
| | 4 | 98% | K | 8.3 | 0.5 |
| | | 2% | N | | |
| | 5 | 75% | L | 8.3 | 0.5 |
| | | 23% | K | | |
| | | 2% | N | | |
| | 6 | 98% | K | 8.3 | 0.5 |
| | | 2% | N | | |
| | 7 | 75% | L | 8.3 | 0.5 |
| | | 23% | K | | |
| | | 2% | N | | |
| | 8 | 98% | K | 16.7 | 1.0 |
| | | 2% | N | | |
| | 9 | 70% | L | 13.3 | 0.8 |
| | | 28% | K | | |
| | | 2% | N | | |
| Film 31 | 1 | 45% | A | 11.7 | 0.7 |
| | | 42% | B | | |
| | | 13% | U | | |
| | 2 | 100% | K | 19.2 | 1.15 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 19.2 | 1.15 |
| | | 6% | X | | |
| | 9 | 65% | V | 5.0 | 0.3 |
| | | 30% | W | | |
| | | 5% | X | | |
| Film 32 | 1 | 45% | A | 11.7 | 0.7 |
| | | 42% | B | | |
| | | 13% | U | | |
| | 2 | 100% | K | 16.7 | 1.0 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 16.7 | 1.0 |
| | | 6% | X | | |
| | 9 | 65% | V | 10.0 | 0.6 |
| | | 30% | W | | |
| | | 5% | X | | |
| Film 33 | 1 | 70% | A | 11.1 | 0.7 |
| | | 30% | Y | | |
| | 2 | 100% | K | 18.2 | 1.15 |
| | 3 | 75% | L | 8.7 | 0.55 |
| | | 25% | K | | |
| | 4 | 100% | K | 7.9 | 0.5 |
| | 5 | 75% | L | 9.5 | 0.6 |
| | | 25% | K | | |
| | 6 | 100% | K | | 0.5 |
| | 7 | 75% | L | 8.7 | 0.55 |
| | | 25% | K | | |
| | 8 | 94% | K | 18.2 | 1.15 |
| | | 6% | X | | |
| | 9 | 65% | V | 9.5 | 0.6 |
| | | 30% | W | | |
| | | 5% | X | | |
| Film 34 | 1 | 70% | A | 11.7 | 0.7 |
| | | 30% | Y | | |
| | 2 | 100% | K | 16.7 | 1.0 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 16.7 | 1.0 |
| | | 6% | X | | |
| | 9 | 65% | V | 10.0 | 0.6 |
| | | 30% | W | | |
| | | 5% | X | | |
| Film 35 | 1 | 70% | A | 11.7 | 0.7 |
| | | 30% | Y | | |
| | 2 | 100% | K | 19.2 | 1.15 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 19.2 | 1.15 |
| | | 6% | X | | |
| | 9 | 65% | V | 5.0 | 0.3 |
| | | 30% | W | | |
| | | 5% | X | | |
| Film 36 | 1 | 70% | A | 11.7 | 0.7 |
| | | 30% | U | | |
| | 2 | 100% | K | 16.7 | 1.0 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 16.7 | 1.0 |
| | | 6% | X | | |
| | 9 | 65% | V | 10.0 | 0.6 |
| | | 30% | W | | |
| | | 5% | X | | |
| Film 37 | 1 | 70% | A | 11.7 | 0.7 |
| | | 30% | U | | |
| | 2 | 100% | K | 19.2 | 1.15 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 19.2 | 1.15 |
| | | 6% | X | | |
| | 9 | 65% | V | 5.0 | 0.3 |
| | | 30% | W | | |
| | | 5% | X | | |
| Film 38 | 1 | 70% | A | 11.7 | 0.7 |
| | | 30% | U | | |
| | 2 | 100% | K | 16.7 | 1.0 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 16.7 | 1.0 |
| | | 6% | X | | |
| | 9 | 65% | V | 10.0 | 0.6 |
| | | 30% | K | | |
| | | 5% | X | | |
| Film 39 | 1 | 70% | A | 11.7 | 0.7 |
| | | 30% | U | | |
| | 2 | 100% | K | 19.2 | 1.15 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 19.2 | 1.15 |
| | | 6% | X | | |
| | 9 | 65% | V | 5.0 | 0.3 |
| | | 30% | K | | |
| | | 5% | X | | |
| Film 40 | 1 | 70% | A | 11.7 | 0.7 |
| | | 30% | U | | |
| | 2 | 100% | K | 16.7 | 1.0 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 16.7 | 1.0 |
| | | 6% | X | | |
| | 9 | 70% | P | 10.0 | 0.6 |
| | | 30% | U | | |
| Film 41 | 1 | 70% | A | 11.7 | 0.7 |
| | | 30% | U | | |
| | 2 | 100% | K | 19.2 | 1.15 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 19.2 | 1.15 |
| | | 6% | X | | |
| | 9 | 70% | P | 5.0 | 0.3 |
| | | 30% | U | | |
| Film 42 | 1 | 70% | A | 11.7 | 0.7 |
| | | 30% | U | | |
| | 2 | 100% | K | 19.2 | 1.15 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 19.2 | 1.15 |
| | | 6% | X | | |
| | 9 | 70% | P | 5.0 | 0.3 |
| | | 30% | Y | | |
| Film 43 | 1 | 70% | A | 11.7 | 0.7 |
| | | 30% | U | | |
| | 2 | 100% | K | 16.7 | 1.0 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 16.7 | 1.0 |
| | | 6% | X | | |
| | 9 | 70% | P | 10.0 | 0.6 |
| | | 30% | Y | | |
| Film 44 | 1 | 70% | A | 11.7 | 0.7 |
| | | 30% | U | | |
| | 2 | 100% | K | 16.7 | 1.0 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 16.7 | 1.0 |
| | | 6% | X | | |
| | 9 | 70% | P | 10.0 | 0.6 |
| | | 30% | Z | | |
| Film 45 | 1 | 70% | A | 11.7 | 0.7 |
| | | 30% | U | | |
| | 2 | 100% | K | 19.2 | 1.15 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 19.2 | 1.15 |
| | | 6% | X | | |
| | 9 | 70% | P | 5.0 | 0.3 |
| | | 30% | Z | | |
| Film 46 | 1 | 70% | A | 11.7 | 0.7 |
| | | 30% | U | | |
| | 2 | 100% | K | 16.7 | 1.0 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 16.7 | 1.0 |
| | | 6% | X | | |
| | 9 | 58% | P | 10.0 | 0.6 |
| | | 42% | Z | | |
| Film 47 | 1 | 70% | A | 11.7 | 0.7 |
| | | 30% | U | | |
| | 2 | 100% | K | 19.2 | 1.15 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 19.2 | 1.15 |
| | | 6% | X | | |
| | 9 | 58% | P | 5.0 | 0.3 |
| | | 42% | Z | | |
| Film 48 | 1 | 70% | A | 11.7 | 0.7 |
| | | 30% | U | | |
| | 2 | 100% | K | 16.7 | 1.0 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 16.7 | 1.0 |
| | | 6% | X | | |
| | 9 | 70% | M | 10.0 | 0.6 |
| | | 30% | P | | |
| Film 49 | 1 | 70% | A | 11.7 | 0.7 |
| | | 30% | U | | |
| | 2 | 100% | K | 19.2 | 1.15 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 19.2 | 1.15 |
| | | 6% | X | | |
| | 9 | 70% | M | 5.0 | 0.3 |
| | | 30% | P | | |
| Film 50 | 1 | 70% | A | 11.7 | 0.7 |
| | | 30% | U | | |
| | 2 | 100% | K | 16.7 | 1.0 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 16.7 | 1.0 |
| | | 6% | X | | |
| | 9 | 70% | P | 10.0 | 0.6 |
| | | 30% | U | | |
| Film 51 | 1 | 70% | A | 11.7 | 0.7 |
| | | 30% | U | | |
| | 2 | 100% | K | 16.7 | 1.0 |
| | 3 | 75% | L | 9.2 | 0.55 |
| | | 25% | K | | |
| | 4 | 100% | K | 8.3 | 0.5 |
| | 5 | 75% | L | 10.0 | 0.6 |
| | | 25% | K | | |
| | 6 | 100% | K | 8.3 | 0.5 |
| | 7 | 75% | L | 9.2 | 0.55 |
| | | 25% | K | | |
| | 8 | 94% | K | 16.7 | 1.0 |
| | | 6% | X | | |
| | 9 | 70% | P | 10.0 | 0.6 |
| | | 30% | U | | |

### Example 1

### Manufacture of Films 1-51

Films 1-51 were cast coextruded and cross-linked by high-energy electron radiation according to methods well known to those of ordinary skill in the art.

### Example 2

### Tensile and Elongation Testing of Films

Films 1-8, 10-11, 13, and 23-30 were subjected to tensile strength and elongation testing in both the machine direction (MD) and the transverse direction (TD). Tensile strength is a measure of the force required under constant elongation to break a film specimen. Elongation is a measure of the percent extension required to break a specimen of film. The tensile and elongation testing was done in accordance with ASTM D-882. Testing was performed at 73° F. with crosshead speed of 20 in/min. Each film was tested in quadruplicate and the results are given below in Table 3.

TABLE 3
Tensile and Elongation Testing of Films 1-8, 10-11, 13, and 23-30

| | | Tensile | | Tensile | | |
|---|---|---|---|---|---|---|
| | | Str. | Elong. | Str. | Elong. | Thick- |
| | | At Yield | At Yield | At Break | At Break | ness |
| Film | Rep. | (psi) | (%) | (psi) | (%) | (mil) |
| 1 | 1 | 1650 | 15 | 5690 | 670 | 6.24 |
| (MD) | 2 | 1690 | 15 | 5950 | 670 | 6.02 |
| | 3 | 1630 | 15 | 5790 | 680 | 6.20 |
| | 4 | 1680 | 15 | 6070 | 670 | 6.10 |
| | Avg. | 1660 | 15 | 5870 | 670 | 6.14 |
| | St. Dev. | 26.9 | 0.0 | 167 | 5.4 | 0.10 |
| 1 | 1 | 1670 | 15 | 5870 | 760 | 5.92 |
| (TD) | 2 | 1630 | 15 | 5420 | 720 | 5.92 |
| | 3 | 1630 | 15 | 5310 | 740 | 6.10 |
| | 4 | 1620 | 18 | 5580 | 750 | 5.88 |
| | Avg. | 1640 | 16 | 5550 | 740 | 5.96 |
| | St. Dev. | 24.7 | 1.5 | 245 | 19 | 0.10 |
| 2 | 1 | 1770 | 15 | 4500 | 700 | 6.58 |
| (MD) | 2 | 1710 | 15 | 4550 | 680 | 7.40 |
| | 3 | 1760 | 15 | 4560 | 650 | 5.82 |
| | 4 | 1760 | 15 | 4440 | 650 | 7.50 |
| | Avg. | 1750 | 15 | 4510 | 670 | 6.83 |
| | St. Dev. | 28.4 | 0.0 | 55.7 | 23 | 0.79 |
| 2 | 1 | 1610 | 15 | 4380 | 720 | 7.3 |
| (TD) | 2 | 1620 | 16 | 4610 | 700 | 6.24 |
| | 3 | 1670 | 16 | 5070 | 720 | 5.36 |
| | 4 | 1590 | 16 | 4430 | 690 | 5.98 |
| | Avg. | 1630 | 16 | 4620 | 710 | 6.22 |
| | St. Dev. | 34.5 | 0.5 | 314 | 16 | 0.81 |
| 3 | 1 | 1690 | 16 | 6350 | 560 | 5.82 |
| (MD) | 2 | 1750 | 15 | 6310 | 570 | 5.78 |
| | 3 | 1690 | 15 | 6410 | 550 | 5.74 |
| | 4 | 1720 | 15 | 6210 | 540 | 5.58 |
| | Avg. | 1710 | 15 | 6320 | 560 | 5.73 |
| | St. Dev. | 28.9 | 0.5 | 85.3 | 14 | 0.11 |
| 3 | 1 | 1670 | 12 | 5300 | 710 | 5.10 |
| (TD) | 2 | 1650 | 12 | 5400 | 710 | 5.08 |
| | 3 | 1650 | 12 | 5860 | 730 | 5.16 |
| | 4 | 1660 | 13 | 5730 | 730 | 5.34 |
| | Avg. | 1650 | 12 | 5570 | 720 | 5.17 |
| | St. Dev. | 8.51 | 0.50 | 265 | 12 | 0.12 |
| 4 | 1 | 1800 | 15 | 6770 | 610 | 6.24 |
| (MD) | 2 | 1710 | 16 | 6610 | 620 | 6.42 |
| | 3 | 1730 | 15 | 6480 | 610 | 6.34 |
| | 4 | 1720 | 15 | 6440 | 610 | 6.30 |
| | Avg. | 1740 | 15 | 6570 | 610 | 6.33 |
| | St. Dev. | 37.5 | 0.50 | 149 | 4.6 | 0.08 |
| 4 | 1 | 1730 | 12 | 5860 | 760 | 6.10 |
| (TD) | 2 | 1690 | 14 | 5570 | 750 | 6.34 |
| | 3 | 1630 | 13 | 6040 | 770 | 6.24 |
| | 4 | 1690 | 13 | 5910 | 760 | 6.28 |
| | Avg. | 1680 | 13 | 5850 | 760 | 6.24 |
| | St. Dev. | 43.6 | 0.82 | 196 | 12 | 0.10 |
| 5 | 1 | 1670 | 15 | 7270 | 630 | 5.56 |
| (MD) | 2 | 1580 | 15 | 6390 | 630 | 6.68 |
| | 3 | 1800 | 14 | 7050 | 610 | 6.06 |
| | 4 | 1750 | 15 | 7090 | 620 | 5.66 |
| | Avg. | 1700 | 15 | 6950 | 620 | 5.99 |
| | St. Dev. | 64.9 | 0.50 | 383 | 5.7 | 0.51 |
| 5 | 1 | 1580 | 13 | 5030 | 610 | 6.48 |
| (TD) | 2 | 1560 | 13 | 5110 | 620 | 6.30 |
| | 3 | 1640 | 13 | 5120 | 610 | 6.28 |
| | 4 | 1610 | 13 | 5020 | 600 | 6.16 |
| | Avg. | 1600 | 13 | 5070 | 610 | 6.31 |
| | St. Dev. | 36.0 | 0.0 | 51.6 | 5.8 | 0.13 |
| 6 | 1 | 1640 | 15 | 5600 | 600 | 6.14 |
| (MD) | 2 | 1770 | 15 | 5560 | 600 | 6.26 |
| | 3 | 1590 | 15 | 5740 | 610 | 6.18 |
| | 4 | 1680 | 14 | 5230 | 590 | 6.36 |
| | Avg. | 1670 | 15 | 5530 | 600 | 6.24 |
| | St. Dev. | 73.3 | 0.50 | 216 | 6.8 | 0.10 |
| 6 | 1 | 1600 | 15 | 5040 | 690 | 6.24 |
| (TD) | 2 | 1600 | 13 | 5260 | 680 | 6.20 |
| | 3 | 1550 | 13 | 5130 | 690 | 6.22 |
| | 4 | 1570 | 14 | 5240 | 690 | 6.12 |
| | Avg. | 1580 | 14 | 5170 | 690 | 6.20 |
| | St. Dev. | 22.9 | 0.96 | 100 | 4.4 | 0.05 |
| 7 | 1 | 1580 | 16 | 5680 | 580 | 6.14 |
| (MD) | 2 | 1590 | 15 | 5860 | 570 | 5.74 |
| | 3 | 1520 | 15 | 5470 | 580 | 6.60 |
| | 4 | 1610 | 15 | 5930 | 570 | 5.68 |
| | Avg. | 1580 | 15 | 5730 | 570 | 6.04 |
| | St. Dev. | 35.7 | 0.5 | 203 | 5.6 | 0.43 |
| 7 | 1 | 1490 | 14 | 4800 | 600 | 6.32 |
| (TD) | 2 | 1500 | 15 | 4810 | 600 | 6.30 |
| | 3 | 1490 | 14 | 5020 | 620 | 6.18 |
| | 4 | 1510 | 14 | 5430 | 620 | 6.20 |
| | Avg. | 1500 | 14 | 5020 | 610 | 6.25 |
| | St. Dev. | 10.7 | 0.50 | 293 | 11 | 0.07 |
| 8 | 1 | 1510 | 15 | 6160 | 620 | 6.32 |
| (MD) | 2 | 1520 | 17 | 6430 | 640 | 6.20 |
| | 3 | 1 + 30 | 15 | 6150 | 620 | 6.44 |
| | 4 | 1620 | 15 | 6250 | 620 | 6.20 |
| | Avg. | 1570 | 16 | 6250 | 620 | 6.29 |
| | St. Dev. | 63.6 | 1.0 | 130 | 8.1 | 0.11 |
| 8 | 1 | 1490 | 15 | 6080 | 650 | 5.72 |
| (TD) | 2 | 1550 | 15 | 5690 | 630 | 5.80 |
| | 3 | 1560 | 15 | 6290 | 640 | 5.34 |
| | 4 | 1560 | 15 | 5910 | 630 | 5.86 |
| | Avg. | 1540 | 15 | 5990 | 640 | 5.68 |
| | St. Dev. | 34.5 | 0.0 | 265 | 8.8 | 0.23 |
| 10 | 1 | 1390 | 17 | 6400 | 660 | 5.84 |
| (MD) | 2 | 1430 | 17 | 7000 | 690 | 5.54 |
| | 3 | 1570 | 16 | 4810 | 570 | 5.64 |
| | 4 | 1510 | 15 | 5750 | 630 | 5.82 |
| | Avg. | 1480 | 16 | 5990 | 640 | 5.71 |
| | St. Dev. | 79.7 | 0.96 | 936 | 51 | 0.14 |
| 10 | 1 | 1480 | 15 | 5340 | 700 | 5.58 |
| (TD) | 2 | 1510 | 15 | 5360 | 690 | 5.50 |
| | 3 | 1490 | 15 | 5250 | 690 | 5.98 |
| | 4 | 1520 | 15 | 5280 | 700 | 5.70 |
| | Avg. | 1500 | 15 | 5310 | 700 | 5.69 |
| | St. Dev. | 18.3 | 0.0 | 52.1 | 3.0 | 0.21 |
| 11 | 1 | 1580 | 17 | 5120 | 590 | 5.62 |
| (MD) | 2 | 1500 | 17 | 5320 | 610 | 5.78 |
| | 3 | 1590 | 15 | 6210 | 660 | 5.44 |
| | 4 | 1550 | 15 | 6260 | 650 | 5.40 |
| | Avg. | 1550 | 16 | 5730 | 630 | 5.56 |
| | St. Dev. | 39.4 | 1.2 | 593 | 32 | 0.18 |
| 11 | 1 | 1340 | 14 | 5540 | 720 | 5.44 |
| (TD) | 2 | 1530 | 15 | 5340 | 700 | 5.72 |
| | 3 | 1520 | 15 | 5100 | 690 | 5.64 |
| | 4 | 1440 | 14 | 6150 | 720 | 5.12 |
| | Avg. | 1460 | 15 | 5630 | 710 | 5.48 |
| | St. Dev. | 89.7 | 0.58 | 451 | 17 | 0.27 |
| 13 | 1 | 1750 | 14 | 5510 | 610 | 6.86 |
| (MD) | 2 | 1790 | 15 | 5790 | 600 | 6.02 |
| | 3 | 1740 | 14 | 6420 | 630 | 6.22 |
| | 4 | 1730 | 15 | 6230 | 630 | 6.52 |
| | Avg. | 1750 | 15 | 5990 | 620 | 6.41 |
| | St. Dev. | 24.8 | 0.58 | 412 | 17 | 0.37 |
| 13 | 1 | 1700 | 17 | 4920 | 640 | 6.32 |
| (TD) | 2 | 1670 | 17 | 5510 | 660 | 6.06 |
| | 3 | 1680 | 15 | 5440 | 660 | 5.68 |
| | 4 | 1670 | 17 | 5230 | 650 | 6.52 |
| | Avg. | 1680 | 16 | 5280 | 650 | 6.15 |
| | St. Dev. | 14.3 | 1.0 | 267 | 10 | 0.36 |
| 23 | 1 | 1760 | 14 | 6040 | 640 | 5.72 |
| (MD) | 2 | 1680 | 15 | 5800 | 630 | 5.68 |
| | 3 | 1790 | 14 | 5830 | 660 | 6.36 |
| | 4 | 1670 | 15 | 6320 | 640 | 5.64 |
| | Avg. | 1730 | 15 | 6000 | 650 | 5.85 |
| | St. Dev. | 58.0 | 0.58 | 241 | 13 | 0.34 |
| 23 | 1 | 1750 | 16 | 4710 | 680 | 6.22 |
| (TD) | 2 | 1640 | 16 | 4930 | 690 | 5.92 |
| | 3 | 1610 | 17 | 4720 | 690 | 5.98 |
| | 4 | 1740 | 17 | 4910 | 710 | 7.24 |
| | Avg. | 1680 | 16 | 4820 | 690 | 6.34 |
| | St. Dev. | 72.7 | 0.58 | 118 | 12 | 0.61 |
| 24 | 1 | 1900 | 14 | 6010 | 630 | 6.22 |
| (MD) | 2 | 1850 | 14 | 6080 | 620 | 5.80 |
| | 3 | 1950 | 14 | 5780 | 610 | 6.04 |
| | 4 | 1780 | 14 | 5870 | 620 | 5.90 |
| | Avg. | 1870 | 14 | 5930 | 620 | 5.99 |
| | St. Dev. | 71.9 | 0 | 136 | 6.4 | 0.18 |
| 24 | 1 | 1680 | 14 | 5870 | 650 | 5.84 |
| (TD) | 2 | 1750 | 15 | 5710 | 640 | 6.14 |
| | 3 | 1770 | 16 | 5660 | 650 | 6.18 |
| | 4 | 1780 | 16 | 5810 | 660 | 6.14 |
| | Avg. | 1740 | 15 | 5760 | 650 | 6.08 |
| | St. Dev. | 46.2 | 0.96 | 95.2 | 6.5 | 0.16 |
| 25 | 1 | 1930 | 14 | 5690 | 610 | 6.76 |
| (MD) | 2 | 1890 | 14 | 6180 | 630 | 6.52 |
| | 3 | 1850 | 14 | 5700 | 610 | 6.56 |
| | 4 | 1820 | 14 | 5180 | 590 | 6.40 |
| | Avg. | 1870 | 14 | 5690 | 610 | 6.56 |
| | St. Dev. | 46.8 | 0 | 408 | 15 | 0.15 |
| 25 | 1 | 1670 | 15 | 6080 | 650 | 6.08 |
| (TD) | 2 | 1700 | 15 | 5860 | 640 | 6.26 |
| | 3 | 1740 | 16 | 5900 | 640 | 6.22 |
| | 4 | 1670 | 16 | 5710 | 640 | 6.34 |
| | Avg. | 1700 | 15 | 5890 | 640 | 6.23 |
| | St. Dev. | 31.4 | 0.58 | 151 | 5.4 | 0.11 |
| 26 | 1 | 1830 | 14 | 5490 | 610 | 6.26 |
| (MD) | 2 | 1930 | 14 | 6050 | 630 | 6.46 |
| | 3 | 1780 | 14 | 5990 | 610 | 6.12 |
| | 4 | 1910 | 14 | 5980 | 620 | 6.64 |
| | Avg. | 1860 | 14 | 5880 | 620 | 6.37 |
| | St. Dev. | 72.3 | 0.0 | 261 | 12 | 0.23 |
| 26 | 1 | 1800 | 14 | 5470 | 630 | 6.28 |
| (TD) | 2 | 1790 | 15 | 5650 | 640 | 6.44 |
| | 3 | 1790 | 15 | 5160 | 600 | 6.22 |
| | 4 | 1800 | 15 | 5300 | 620 | 6.40 |
| | Avg. | 1790 | 15 | 5390 | 620 | 6.34 |
| | St. Dev. | 8.10 | 0.50 | 212 | 17 | 0.10 |
| 27 | 1 | 2010 | 13 | 6160 | 620 | 6.46 |
| (MD) | 2 | 1930 | 13 | 5860 | 620 | 6.14 |
| | 3 | 1970 | 13 | 6030 | 620 | 6.40 |
| | 4 | 2020 | 13 | 6460 | 600 | 6.64 |
| | Avg. | 1980 | 13 | 5880 | 620 | 6.41 |
| | St. Dev. | 41.6 | 0.0 | 304 | 11 | 0.21 |
| 27 | 1 | 1890 | 14 | 4540 | 570 | 6.48 |
| (TD) | 2 | 1890 | 14 | 4500 | 580 | 6.72 |
| | 3 | 1970 | 14 | 4660 | 580 | 6.36 |
| | 4 | 1980 | 13 | 4890 | 590 | 6.18 |
| | Avg. | 1930 | 14 | 4650 | 580 | 6.44 |
| | St. Dev. | 50.7 | 0.50 | 176 | 5.6 | 0.23 |
| 28 | 1 | 1640 | 15 | 6250 | 660 | 6.46 |
| (MD) | 2 | 1640 | 15 | 6130 | 660 | 6.36 |
| | 3 | 1730 | 15 | 6740 | 640 | 5.78 |
| | 4 | 1690 | 14 | 6750 | 660 | 6.02 |
| | Avg. | 1670 | 15 | 6470 | 660 | 6.16 |
| | St. Dev. | 45.2 | 0.5 | 326 | 8.8 | 0.31 |
| 28 | 1 | 1540 | 15 | 5200 | 670 | 6.08 |
| (TD) | 2 | 1700 | 17 | 6230 | 680 | 5.08 |
| | 3 | 1490 | 17 | 5230 | 690 | 7.02 |
| | 4 | 1560 | 16 | 5340 | 670 | 6.20 |
| | Avg. | 1570 | 16 | 5500 | 680 | 6.10 |
| | St. Dev. | 91.3 | 0.96 | 92 | 12 | 0.80 |
| 29 | 1 | 1790 | 14 | 5690 | 620 | 5.36 |
| (MD) | 2 | 1820 | 14 | 5790 | 630 | 5.44 |
| | 3 | 1860 | 15 | 5880 | 630 | 5.92 |
| | 4 | 1820 | 15 | 5850 | 630 | 5.74 |
| | Avg. | 1820 | 14 | 5800 | 630 | 5.62 |
| | St. Dev. | 28.8 | 0.58 | 81.7 | 4.3 | 0.26 |
| 29 | 1 | 1800 | 17 | 4380 | 650 | 6.04 |
| (TD) | 2 | 1720 | 16 | 4460 | 660 | 5.98 |
| | 3 | 1740 | 17 | 4550 | 670 | 5.74 |
| | 4 | 1760 | 15 | 4440 | 660 | 5.80 |
| | Avg. | 1760 | 16 | 4460 | 660 | 5.89 |
| | St. Dev. | 34.2 | 0.96 | 73.8 | 8.0 | 0.14 |
| 30 | 1 | — | — | 6940 | 640 | 4.50 |
| (MD) | 2 | — | — | 6790 | 620 | 4.48 |
| | 3 | — | — | 7390 | 630 | 4.26 |
| | 4 | — | — | 7820 | 640 | 4.04 |
| | Avg. | — | — | 7230 | 630 | 4.32 |
| | St. Dev. | — | — | 467 | 12 | 0.22 |
| 30 | 1 | 1800 | 13 | 6710 | 660 | 5.8 |
| (TD) | 2 | 1660 | 13 | 4830 | 610 | 7.06 |
| | 3 | 1690 | 13 | 6440 | 690 | 6.90 |
| | 4 | 1690 | 13 | 5580 | 640 | 6.38 |
| | Avg. | 1710 | 13 | 5890 | 650 | 6.54 |
| | St. Dev. | 61.6 | 0.0 | 854 | 34 | 0.57 |

### Example 3

### Young's Modulus Testing of Films 1-8, 10-11, 13, and 23-30

The Young's Modulus of Films 1-8, 10-11, 13, and 23-30 was tested at 73° F. in both the longitudinal and transverse directions. Young's modulus is a measure of the elasticity of the film and is measured in accordance with ASTM D6638. Samples were tested in quadruplicate and the results are shown below in Table 4.

TABLE 4
Young's Modulus Testing of Films 1-8, 10-11, 13, 23-30

| Film | Rep. | Modulus (psi) | Thickness (mil) |
|---|---|---|---|
| 1 (MD) | 1 | 39000 | 6.24 |
| | 2 | 39700 | 6.02 |
| | 3 | 38700 | 6.20 |
| | 4 | 39900 | 6.10 |
| | Avg. | 39300 | 6.14 |
| | Std. Dev. | 583 | 0.10 |
| 1 (TD) | 1 | 42100 | 5.92 |
| | 2 | 38900 | 5.92 |
| | 3 | 41000 | 6.10 |
| | 4 | 9150 | 5.88 |
| | Avg. | 32800 | 5.96 |
| | Std. Dev. | 15800 | 0.10 |
| 2 (MD) | 1 | 49500 | 6.58 |
| | 2 | 45800 | 7.40 |
| | 3 | 47900 | 5.82 |
| | 4 | 47900 | 7.50 |
| | Avg. | 47800 | 6.83 |
| | Std. Dev. | 1530 | 0.79 |
| 2 (TD) | 1 | 40800 | 7.30 |
| | 2 | 42100 | 6.24 |
| | 3 | 43400 | 5.36 |
| | 4 | 41000 | 5.98 |
| | Avg. | 41800 | 6.22 |
| | Std. Dev. | 1190 | 0.81 |
| 3 (MD) | 1 | 41200 | 5.82 |
| | 2 | 44100 | 5.78 |
| | 3 | 41300 | 5.74 |
| | 4 | 41200 | 5.58 |
| | Avg. | 41900 | 5.73 |
| | Std. Dev. | 1410 | 0.11 |
| 3 (TD) | 1 | 42800 | 5.10 |
| | 2 | 45900 | 5.08 |
| | 3 | 44900 | 5.16 |
| | 4 | 42200 | 5.34 |
| | Avg. | 44000 | 5.17 |
| | Std. Dev. | 1770 | 0.12 |
| 4 (MD) | 1 | 43500 | 6.24 |
| | 2 | 39900 | 6.42 |
| | 3 | 40900 | 6.34 |
| | 4 | 40800 | 6.30 |
| | Avg. | 41300 | 6.33 |
| | Std. Dev. | 1530 | 0.08 |
| 4 (TD) | 1 | 46300 | 6.10 |
| | 2 | 43900 | 6.34 |
| | 3 | 41400 | 6.24 |
| | 4 | 42200 | 6.28 |
| | Avg. | 43400 | 6.24 |
| | Std. Dev. | 2150 | 0.10 |
| 5 (MD) | 1 | 41200 | 5.56 |
| | 2 | 40800 | 6.68 |
| | 3 | 44300 | 6.06 |
| | 4 | 43400 | 5.66 |
| | Avg. | 42400 | 5.99 |
| | Std. Dev. | 1730 | 0.51 |
| 5 (TD) | 1 | 39000 | 6.48 |
| | 2 | 40700 | 6.30 |
| | 3 | 39900 | 6.28 |
| | 4 | 38600 | 6.16 |
| | Avg. | 39600 | 6.31 |
| | Std. Dev. | 946 | 0.13 |
| 6 (MD) | 1 | 40800 | 6.14 |
| | 2 | 42300 | 6.26 |
| | 3 | 39100 | 6.18 |
| | 4 | 38400 | 6.36 |
| | Avg. | 40200 | 6.24 |
| | Std. Dev. | 1740 | 0.10 |
| 6 (TD) | 1 | 40900 | 6.24 |
| | 2 | 40400 | 6.20 |
| | 3 | 37000 | 6.22 |
| | 4 | 40300 | 6.12 |
| | Avg. | 39600 | 6.20 |
| | Std. Dev. | 1760 | 0.05 |
| 7 (MD) | 1 | 35800 | 6.14 |
| | 2 | 36200 | 5.74 |
| | 3 | 33700 | 6.60 |
| | 4 | 37100 | 5.68 |
| | Avg. | 35700 | 6.04 |
| | Std. Dev. | 1420 | 0.43 |
| 7 (TD) | 1 | 33600 | 6.32 |
| | 2 | 35300 | 6.30 |
| | 3 | 33500 | 6.18 |
| | 4 | 34700 | 6.20 |
| | Avg. | 34300 | 6.25 |
| | Std. Dev. | 859 | 0.07 |
| 8 (MD) | 1 | 33600 | 6.32 |
| | 2 | 34800 | 6.20 |
| | 3 | 35700 | 6.44 |
| | 4 | 36900 | 6.20 |
| | Avg. | 35300 | 6.29 |
| | Std. Dev. | 1400 | 0.11 |
| 8 (TD) | 1 | 33600 | 5.72 |
| | 2 | 35800 | 5.80 |
| | 3 | 35800 | 5.34 |
| | 4 | 37600 | 5.86 |
| | Avg. | 35700 | 5.68 |
| | Std. Dev. | 1640 | 0.23 |
| 10 (MD) | 1 | 32600 | 5.84 |
| | 2 | 31700 | 5.54 |
| | 3 | 34800 | 5.64 |
| | 4 | 35400 | 5.82 |
| | Avg. | 33600 | 5.71 |
| | Std. Dev. | 1760 | 0.14 |
| 10 (TD) | 1 | 34800 | 5.58 |
| | 2 | 34300 | 5.50 |
| | 3 | 35100 | 5.98 |
| | 4 | 35700 | 5.70 |
| | Avg. | 35000 | 5.69 |
| | Std. Dev. | 585 | 0.21 |
| 11 (MD) | 1 | 35000 | 5.62 |
| | 2 | 33000 | 5.78 |
| | 3 | 35600 | 5.44 |
| | 4 | 34600 | 5.40 |
| | Avg. | 34600 | 5.56 |
| | Std. Dev. | 1110 | 0.18 |
| 11 (TD) | 1 | 29500 | 5.44 |
| | 2 | 35100 | 5.72 |
| | 3 | 33300 | 5.64 |
| | 4 | 33100 | 5.12 |
| | Avg. | 32800 | 5.48 |
| | Std. Dev. | 2350 | 0.27 |
| 13 (MD) | 1 | 44500 | 6.86 |
| | 2 | 44400 | 6.02 |
| | 3 | 41400 | 6.22 |
| | 4 | 41300 | 6.52 |
| | Avg. | 42900 | 6.41 |
| | Std. Dev. | 1790 | 0.37 |
| 13 (TD) | 1 | 41200 | 6.32 |
| | 2 | 40200 | 6.06 |
| | 3 | 39100 | 5.68 |
| | 4 | 37500 | 6.52 |
| | Avg. | 39500 | 6.15 |
| | Std. Dev. | 1590 | 0.36 |
| 23 (MD) | 1 | 42200 | 5.72 |
| | 2 | 38800 | 5.68 |
| | 3 | 44200 | 6.36 |
| | 4 | 40700 | 5.64 |
| | Avg. | 41500 | 5.85 |
| | Std. Dev. | 2290 | 0.34 |
| 23 (TD) | 1 | 39000 | 6.22 |
| | 2 | 37000 | 5.92 |
| | 3 | 37100 | 5.98 |
| | 4 | 40100 | 7.24 |
| | Avg. | 38300 | 6.34 |
| | Std. Dev. | 1510 | 0.61 |
| 24 (MD) | 1 | 47200 | 6.22 |
| | 2 | 45500 | 5.80 |
| | 3 | 49500 | 6.04 |
| | 4 | 44200 | 5.90 |
| | Avg. | 46600 | 5.99 |
| | Std. Dev. | 2290 | 0.18 |
| 24 (TD) | 1 | 39100 | 5.84 |
| | 2 | 40100 | 6.14 |
| | 3 | 40300 | 6.18 |
| | 4 | 41100 | 6.14 |
| | Avg. | 40200 | 6.08 |
| | Std. Dev. | 823 | 0.16 |
| 25 (MD) | 1 | 47300 | 6.76 |
| | 2 | 45900 | 6.52 |
| | 3 | 46500 | 6.56 |
| | 4 | 44700 | 6.40 |
| | Avg. | 46100 | 6.56 |
| | Std. Dev. | 1100 | 0.15 |
| 25 (TD) | 1 | 38000 | 6.08 |
| | 2 | 37900 | 6.26 |
| | 3 | 40100 | 6.22 |
| | 4 | 39300 | 6.34 |
| | Avg. | 38800 | 6.23 |
| | Std. Dev. | 1060 | 0.11 |
| 26 (MD) | 1 | 45500 | 6.26 |
| | 2 | 48500 | 6.46 |
| | 3 | 41700 | 6.12 |
| | 4 | 47300 | 6.64 |
| | Avg. | 45800 | 6.37 |
| | Std. Dev. | 2970 | 0.23 |
| 26 (TD) | 1 | 42600 | 6.28 |
| | 2 | 41000 | 6.44 |
| | 3 | 41400 | 6.22 |
| | 4 | 41300 | 6.40 |
| | Avg. | 41600 | 6.34 |
| | Std. Dev. | 704 | 0.10 |
| 27 (MD) | 1 | 53700 | 6.46 |
| | 2 | 49000 | 6.14 |
| | 3 | 52100 | 6.40 |
| | 4 | 52700 | 6.64 |
| | Avg. | 51900 | 6.41 |
| | Std. Dev. | 2030 | 0.21 |
| 27 (TD) | 1 | 46500 | 6.48 |
| | 2 | 45000 | 6.72 |
| | 3 | 50200 | 6.36 |
| | 4 | 48600 | 6.18 |
| | Avg. | 47600 | 6.44 |
| | Std. Dev. | 2290 | 0.23 |
| 28 (MD) | 1 | 38900 | 6.46 |
| | 2 | 38700 | 6.36 |
| | 3 | 41300 | 5.78 |
| | 4 | 40700 | 6.02 |
| | Avg. | 39900 | 6.16 |
| | Std. Dev. | 1300 | 0.31 |
| 28 (TD) | 1 | 34700 | 6.08 |
| | 2 | 39300 | 5.08 |
| | 3 | 33800 | 7.02 |
| | 4 | 34500 | 6.20 |
| | Avg. | 35600 | 6.10 |
| | Std. Dev. | 2510 | 0.80 |
| 29 (MD) | 1 | 43300 | 5.36 |
| | 2 | 44300 | 5.44 |
| | 3 | 43600 | 5.92 |
| | 4 | 44200 | 5.74 |
| | Avg. | 43900 | 5.62 |
| | Std. Dev. | 480 | 0.26 |
| 29 (TD) | 1 | 40600 | 6.04 |
| | 2 | 39300 | 5.98 |
| | 3 | 38300 | 5.74 |
| | 4 | 40300 | 5.80 |
| | Avg. | 39600 | 5.89 |
| | Std. Dev. | 1040 | 0.14 |
| 30 (MD) | 1 | 35200 | 4.50 |
| | 2 | 36700 | 4.48 |
| | 3 | 36400 | 4.26 |
| | 4 | 38200 | 4.04 |
| | Avg. | 36600 | 4.32 |
| | Std. Dev. | 1230 | 0.22 |
| 30 (TD) | 1 | 44200 | 5.80 |
| | 2 | 41000 | 7.06 |
| | 3 | 40800 | 6.90 |
| | 4 | 41400 | 6.38 |
| | Avg. | 41900 | 6.54 |
| | Std. Dev. | 1590 | 0.57 |

### Example 4

### Instrumented Impact Testing of Films 1-7, 8, 10, 11, 13, and 23-30

The instrumented impact of Films 1-7, 8, 10, 11, 13, and 23-30 was tested. The instrumented impact is the energy necessary to puncture a restrained specimen of film, and is measured in accordance with ASTM D-3763. Samples were tested in quadruplicate. Results are shown below in Table 5.

TABLE 5
Instrumented Impact Testing of Films 1-7, 8, 10, 11, 13, and 23-30

| | | | | | | Dis- | |
|---|---|---|---|---|---|---|---|
| | | | | Ener- | Ener- | place- | |
| | | Peak | Break | gy to | gy to | ment to | Thick- |
| | | Load | Load | Peak | Break | Break | ness |
| Film | Rep. | (N) | (N) | (J) | (J) | (mm) | (mil) |
| 1 | 1 | 66.54 | 66.60 | 0.68 | 0.68 | 16.15 | 6.21 |
| | 2 | 69.48 | 69.48 | 0.64 | 0.64 | 16.51 | 6.06 |
| | 3 | 72.95 | 72.95 | 0.981 | 0.81 | 18.85 | 6.09 |
| | 4 | 66.53 | 66.53 | 0.73 | 0.73 | 17.09 | 6.22 |
| | Avg. | 68.88 | 68.89 | 0.72 | 0.72 | 17.15 | 6.15 |
| | St. Dev. | 3.05 | 3.04 | 0.07 | 0.07 | 1.20 | 0.08 |
| 2 | 1 | 61.87 | 61.87 | 0.47 | 0.47 | 14.45 | 5.62 |
| | 2 | 56.49 | 56.49 | 0.83 | 0.83 | 45.71 | 4.78 |
| | 3 | 51.90 | 51.90 | 0.78 | 0.78 | 45.05 | 5.04 |
| | 4 | 78.02 | 78.08 | 0.65 | 0.65 | 15.64 | 6.99 |
| | Avg. | 62.07 | 62.07 | 0.68 | 0.68 | 30.21 | 5.61 |
| | St. Dev. | 11.39 | 11.39 | 0.16 | 0.16 | 17.52 | 0.99 |
| 3 | 1 | 84.90 | 84.90 | 1.23 | 1.23 | 22.04 | 6.75 |
| | 2 | 92.18 | 92.18 | 1.74 | 1.74 | 28.40 | 6.48 |
| | 3 | 69.75 | 69.75 | 0.99 | 0.99 | 21.44 | 5.95 |
| | 4 | 87.40 | 87.40 | 1.24 | 1.24 | 23.63 | 6.23 |
| | Avg. | 83.56 | 83.56 | 1.30 | 1.30 | 23.88 | 6.35 |
| | St. Dev. | 9.69 | 9.69 | 0.32 | 0.32 | 3.15 | 0.34 |
| 4 | 1 | 74.27 | 74.40 | 0.99 | 0.99 | 20.27 | 6.03 |
| | 2 | 72.30 | 72.30 | 0.96 | 0.96 | 20.11 | 5.93 |
| | 3 | 47.22 | 74.22 | 1.08 | 1.08 | 21.25 | 6.12 |
| | 4 | 60.89 | 60.89 | 0.41 | 0.41 | 13.03 | 6.18 |
| | Avg. | 70.42 | 70.45 | 0.86 | 0.86 | 18.67 | 6.07 |
| | St. Dev. | 6.42 | 6.45 | 0.30 | 0.30 | 3.79 | 0.11 |
| 5 | 1 | 82.81 | 82.81 | 1.04 | 1.04 | 19.76 | 6.32 |
| | 2 | 103.88 | 102.96 | 1.79 | 1.79 | 28.30 | 6.38 |
| | 3 | 78.01 | 77.94 | 1.10 | 1.10 | 21.86 | 5.84 |
| | 4 | 90.75 | 91.01 | 1.40 | 1.40 | 24.13 | 6.28 |
| | Avg. | 88.86 | 88.68 | 1.33 | 1.33 | 23.52 | 6.21 |
| | St. Dev. | 11.31 | 10.94 | 0.34 | 0.34 | 3.65 | 0.25 |
| 6 | 1 | 84.24 | 82.24 | 1.00 | 1.00 | 20.56 | 6.31 |
| | 2 | 85.76 | 85.76 | 1.15 | 1.15 | 21.94 | 6.41 |
| | 3 | 73.88 | 74.14 | 0.83 | 0.83 | 17.47 | 6.29 |
| | 4 | 86.86 | 86.86 | 1.35 | 1.35 | 24.71 | 6.26 |
| | Avg. | 82.69 | 82.75 | 1.08 | 1.08 | 21.17 | 6.32 |
| | St. Dev. | 5.97 | 5.84 | 0.22 | 0.22 | 3.01 | 0.07 |
| 7 | 1 | 102.11 | 102.11 | 2.47 | 2.47 | 36.88 | 6.24 |
| | 2 | 100.26 | 100.46 | 2.34 | 2.34 | 35.90 | 6.06 |
| | 3 | 108.78 | 108.78 | 2.39 | 2.39 | 34.14 | 6.38 |
| | 4 | 110.71 | 110.71 | 2.23 | 2.23 | 32.73 | 6.44 |
| | Avg. | 105.47 | 105.52 | 2.36 | 2.36 | 34.91 | 6.28 |
| | St. Dev. | 5.06 | 4.99 | 0.10 | 0.10 | 1.84 | 0.17 |
| 8 | 1 | 150.01 | 150.14 | 6.46 | 6.46 | 65.01 | 6.34 |
| | 2 | 143.62 | 143.62 | 5.81 | 5.81 | 62.43 | 5.90 |
| | 3 | 146.01 | 146.01 | 5.71 | 5.71 | 60.78 | 5.94 |
| | 4 | 151.70 | 151.70 | 7.24 | 7.24 | 69.19 | 6.10 |
| | Avg. | 147.87 | 147.87 | 6.31 | 6.31 | 64.35 | 6.07 |
| | St. Dev. | 3.71 | 3.71 | 0.71 | 0.71 | 3.66 | 0.20 |
| 10 | 1 | 124.86 | 124.86 | 4.10 | 4.10 | 50.43 | 6.58 |
| | 2 | 116.33 | 116.33 | 3.91 | 3.91 | 52.75 | 6.12 |
| | 3 | 110.16 | 110.16 | 4.40 | 4.40 | 59.29 | 5.48 |
| | 4 | 116.98 | 116.98 | 3.95 | 3.95 | 51.81 | 5.86 |
| | Avg. | 117.08 | 117.08 | 4.09 | 4.09 | 53.57 | 6.01 |
| | St. Dev. | 6.03 | 6.03 | 0.22 | 0.22 | 3.93 | 0.46 |
| 11 | 1 | 105.20 | 105.20 | 4.26 | 4.26 | 60.59 | 5.36 |
| | 2 | 99.20 | 99.20 | 3.10 | 3.10 | 47.48 | 5.46 |
| | 3 | 116.92 | 116.92 | 4.66 | 4.66 | 59.75 | 5.66 |
| | 4 | 123.75 | 123.75 | 5.33 | 5.33 | 63.96 | 5.80 |
| | Avg. | 111.27 | 111.27 | 4.34 | 4.34 | 57.95 | 5.57 |
| | St. Dev. | 11.11 | 11.11 | 0.94 | 0.94 | 7.21 | 0.20 |
| 13 | 1 | 120.27 | 120.27 | 2.84 | 2.84 | 37.62 | 6.56 |
| | 2 | 107.87 | 107.87 | 2.67 | 2.67 | 39.28 | 5.82 |
| | 3 | 108.78 | 108.78 | 2.24 | 2.24 | 33.80 | 5.86 |
| | 4 | 115.34 | 115.34 | 2.58 | 2.58 | 37.74 | 6.02 |
| | Avg. | 113.07 | 113.07 | 2.58 | 2.58 | 37.11 | 6.07 |
| | St. Dev. | 5.84 | 5.84 | 0.25 | 0.25 | 2.33 | 0.34 |
| 23 | 1 | 96.54 | 96.52 | 1.61 | 1.61 | 27.72 | 6.50 |
| | 2 | 90.34 | 90.34 | 1.50 | 1.50 | 27.39 | 5.72 |
| | 3 | 101.04 | 101.04 | 1.81 | 1.81 | 28.85 | 6.28 |
| | 4 | 90.47 | 90.47 | 1.55 | 1.55 | 27.10 | 6.10 |
| | Avg. | 94.59 | 94.59 | 1.62 | 1.62 | 27.77 | 6.15 |
| | St. Dev. | 5.18 | 5.18 | 0.14 | 0.14 | 0.77 | 0.33 |
| 24 | 1 | 110.63 | 110.63 | 1.72 | 1.72 | 26.32 | 6.30 |
| | 2 | 120.53 | 120.53 | 2.53 | 2.53 | 34.12 | 6.70 |
| | 3 | 117.70 | 117.70 | 1.78 | 1.78 | 26.04 | 7.06 |
| | 4 | 127.81 | 127.81 | 2.45 | 2.45 | 32.41 | 6.92 |
| | Avg. | 119.17 | 119.17 | 2.12 | 2.12 | 29.72 | 6.75 |
| | St. Dev. | 7.11 | 7.11 | 0.43 | 0.43 | 4.15 | 0.33 |
| 25 | 1 | 112.74 | 112.74 | 1.81 | 1.81 | 27.19 | 6.42 |
| | 2 | 120.45 | 120.45 | 2.36 | 2.36 | 31.83 | 6.50 |
| | 3 | 114.16 | 114.16 | 2.05 | 2.05 | 29.20 | 6.62 |
| | 4 | 111.42 | 111.42 | 2.07 | 2.07 | 30.94 | 6.52 |
| | Avg. | 114.69 | 114.69 | 2.07 | 2.07 | 29.79 | 6.52 |
| | St. Dev. | 4.00 | 4.00 | 0.23 | 0.23 | 2.05 | 0.08 |
| 26 | 1 | 109.97 | 109.97 | 1.70 | 1.70 | 25.21 | 6.78 |
| | 2 | 116.28 | 116.28 | 2.06 | 2.06 | 29.55 | 6.52 |
| | 3 | 114.89 | 114.89 | 2.22 | 2.22 | 31.17 | 6.48 |
| | 4 | 103.87 | 103.87 | 1.49 | 1.49 | 24.39 | 6.68 |
| | Avg. | 111.25 | 111.25 | 1.87 | 1.87 | 27.58 | 6.62 |
| | St. Dev. | 5.62 | 5.62 | 0.33 | 0.33 | 3.29 | 0.14 |
| 27 | 1 | 112.26 | 112.26 | 1.72 | 1.72 | 25.26 | 7.02 |
| | 2 | 108.00 | 108.00 | 1.74 | 1.74 | 25.92 | 6.78 |
| | 3 | 101.77 | 101.77 | 1.42 | 1.42 | 24.27 | 6.54 |
| | 4 | 101.51 | 101.51 | 1.54 | 1.54 | 24.93 | 6.36 |
| | Avg. | 105.89 | 105.89 | 1.61 | 1.61 | 25.10 | 6.68 |
| | St. Dev. | 5.20 | 5.20 | 0.15 | 0.15 | 0.69 | 0.29 |
| 28 | 1 | 124.42 | 124.42 | 3.52 | 3.52 | 43.45 | 6.38 |
| | 2 | 108.93 | 108.93 | 3.10 | 3.10 | 45.76 | 5.42 |
| | 3 | 113.38 | 113.38 | 3.39 | 3.39 | 46.31 | 5.96 |
| | 4 | 105.57 | 105.57 | 2.73 | 2.73 | 41.04 | 5.64 |
| | Avg. | 113.08 | 113.08 | 3.19 | 3.19 | 44.14 | 5.85 |
| | St. Dev. | 8.21 | 8.21 | 0.35 | 0.35 | 2.41 | 0.42 |
| 29 | 1 | 85.97 | 85.97 | 1.28 | 1.28 | 24.56 | 6.18 |
| | 2 | 89.90 | 89.90 | 1.44 | 1.44 | 25.60 | 6.12 |
| | 3 | 87.27 | 87.27 | 1.25 | 1.25 | 23.84 | 6.22 |
| | 4 | 87.86 | 87.86 | 1.10 | 1.10 | 21.44 | 6.28 |
| | Avg. | 87.75 | 87.75 | 1.27 | 1.27 | 23.86 | 6.20 |
| | St. Dev. | 1.64 | 1.64 | 0.14 | 0.14 | 1.77 | 0.07 |
| 30 | 1 | 96.45 | 96.45 | 3.04 | 3.04 | 49.43 | 4.56 |
| | 2 | 131.75 | 131.75 | 4.02 | 4.02 | 47.86 | 6.16 |
| | 3 | 108.72 | 108.72 | 3.47 | 3.47 | 49.97 | 4.86 |
| | 4 | 147.71 | 147.71 | 4.68 | 4.68 | 50.76 | 6.32 |
| | Avg. | 121.16 | 121.16 | 3.80 | 3.80 | 49.51 | 5.48 |
| | St. Dev. | 22.97 | 22.97 | 0.71 | 0.71 | 1.23 | 0.89 |

### Example 5

### Moisture Vapor Transmission Rate of Films 1-30

The moisture vapor transmission rate of Films 1-30 was measured in accordance with ASTM F-1249, whereby one side of a film specimen was exposed to moisture vapor under controlled conditions and the steady-state transmission rate was measured at the opposite surface of the film. The samples were tested in triplicate at 100° F. and 100% humidity. Samples 8, 11, and 13 were tested twice. Film A is Meliflex Polyolefin Alloy, available from Melitek (Denmark). Results are shown below in Table 6.

TABLE 6
Moisture Vapor Transmission Rate of Films 1-30

| | | MVTR | |
|---|---|---|---|
| Film | Rep | (g/100 in²-day) | Thickness (mil) |
| 1 | 1 | 0.20 | 6.18 |
| | 2 | 0.20 | 6.11 |
| | 3 | 0.20 | 6.01 |
| 2 | 1 | 0.23 | 5.99 |
| | 2 | 0.28 | 5.11 |
| | 3 | 0.20 | 7.27 |
| 3 | 1 | 0.21 | 6.18 |
| | 2 | 0.20 | 6.24 |
| | 3 | 0.22 | 5.54 |
| 4 | 1 | 0.21 | 6.07 |
| | 2 | 0.22 | 6.00 |
| | 3 | 0.21 | 5.98 |
| 5 | 1 | 0.22 | 6.33 |
| | 2 | 0.18 | 6.11 |
| | 3 | 0.20 | 5.84 |
| 6 | 1 | 0.21 | 6.08 |
| | 2 | 0.19 | 6.42 |
| | 3 | 0.20 | 6.33 |
| 7 | 1 | 0.19 | 6.60 |
| | 2 | 0.21 | 6.09 |
| | 3 | 0.21 | 6.14 |
| 8 | 1 | 0.16 | 5.78 |
| | 2 | 0.15 | 6.21 |
| | 3 | 0.13 | 6.10 |
| 8 | 1 | 0.14 | 6.33 |
| | 2 | 0.15 | 5.98 |
| | 3 | 0.16 | 5.94 |
| 9 | 1 | 0.14 | 6.61 |
| | 2 | 0.14 | 6.32 |
| | 3 | 0.14 | 6.15 |
| 10 | 1 | 0.16 | 6.05 |
| | 2 | 0.17 | 6.00 |
| | 3 | 0.18 | 5.70 |
| 11 | 1 | 0.17 | 5.78 |
| | 2 | 0.18 | 5.71 |
| | 3 | 0.18 | 5.67 |
| 11 | 1 | 0.18 | 5.71 |
| | 2 | 0.18 | 5.56 |
| | 3 | 0.19 | 5.40 |
| 12 | 1 | 0.22 | 5.36 |
| | 2 | 0.22 | 5.33 |
| | 3 | 0.19 | 5.98 |
| 13 | 1 | 0.20 | 6.03 |
| | 2 | 0.21 | 6.23 |
| | 3 | 0.21 | 5.97 |
| 13 | 1 | 0.19 | 5.94 |
| | 2 | 0.20 | 5.83 |
| | 3 | 0.22 | 5.65 |
| 14 | 1 | 0.19 | 5.60 |
| | 2 | 0.16 | 6.32 |
| | 3 | 0.16 | 6.26 |
| 15 | 1 | 0.21 | 5.92 |
| | 2 | 0.19 | 6.52 |
| | 3 | 0.18 | 6.94 |
| 16 | 1 | 0.17 | 5.68 |
| | 2 | 0.19 | 5.50 |
| | 3 | 0.18 | 5.98 |
| 17 | 1 | 0.18 | 6.03 |
| | 2 | 0.19 | 6.04 |
| | 3 | 0.19 | 5.75 |
| 18 | 1 | 0.17 | 5.85 |
| | 2 | 0.18 | 5.78 |
| | 3 | 0.17 | 6.06 |
| 19 | 1 | 0.17 | 6.05 |
| | 2 | 0.17 | 6.14 |
| | 3 | 0.19 | 6.11 |
| 20 | 1 | 0.17 | 6.17 |
| | 2 | 0.16 | 6.09 |
| | 3 | 0.17 | 5.78 |
| 21 | 1 | 0.23 | 6.25 |
| | 2 | 0.23 | 6.35 |
| | 3 | 0.27 | 5.89 |
| 22 | 1 | 0.21 | 6.68 |
| | 2 | 0.21 | 6.61 |
| | 3 | 0.21 | 6.28 |
| 23 | 1 | 0.19 | 6.14 |
| | 2 | 0.20 | 6.16 |
| | 3 | 0.19 | 6.38 |
| 24 | 1 | 0.16 | 6357 |
| | 2 | 0.16 | 6.75 |
| | 3 | 0.16 | 6.41 |
| 25 | 1 | 0.21 | 5.47 |
| | 2 | 0.21 | 5.68 |
| | 3 | 0.19 | 6.05 |
| 26 | 1 | 0.18 | 6.28 |
| | 2 | 0.17 | 6.42 |
| | 3 | 0.17 | 6.59 |
| 27 | 1 | 0.16 | 6.42 |
| | 2 | 0.16 | 6.53 |
| | 3 | 0.16 | 6.68 |
| 28 | 1 | 0.19 | 5.53 |
| | 2 | 0.19 | 6.53 |
| | 3 | 0.19 | 6.68 |
| 29 | 1 | 0.19 | 6.06 |
| | 2 | 0.20 | 6.20 |
| | 3 | 0.19 | 6.04 |
| 30 | 1 | 0.17 | 4.88 |
| | 2 | 0.11 | 6.94 |
| | 3 | 0.19 | 4.66 |
| A | 1 | 0.20 | 8.14 |
| | 2 | 0.20 | 8.14 |
| | 3 | 0.22 | 7.74 |

### Example 6

### Oxygen Transmission Rate of Films 1-30

The oxygen transmission rate of Films 1-30 was tested in accordance with ASTM D-3985, whereby one side of a film sample was exposed to oxygen under controlled conditions and the steady-state transmission rate is measured at the opposite surface of the film. The samples were tested in triplicate at 73° F. and 0% humidity inside and outside. Films 8, 11, and 13 were tested twice. Results are shown below in Table 7.

TABLE 7
Oxygen Transmission Rate of Films 1-30

| | | OTR | |
|---|---|---|---|
| Film | Rep | (cc/m²-day-atm) | Thickness (mil) |
| 1 | 1 | 1210 | 6.08 |
| | 2 | 1300 | 6.15 |
| | 3 | 1240 | 6.06 |
| 2 | 1 | 1340 | 6.07 |
| | 2 | 1240 | 6.06 |
| | 3 | 1150 | 7.04 |
| 3 | 1 | 1450 | 5.76 |
| | 2 | 1360 | 6.22 |
| | 3 | 1600 | 5.38 |
| 4 | 1 | 1390 | 6.30 |
| | 2 | 1170 | 6.43 |
| | 3 | 1200 | 6.20 |
| 5 | 1 | 1160 | 6.24 |
| | 2 | 1130 | 6.39 |
| | 3 | 1230 | 5.95 |
| 6 | 1 | 1210 | 6.20 |
| | 2 | 1220 | 6.24 |
| | 3 | 1210 | 6.48 |
| 7 | 1 | 1230 | 6.39 |
| | 2 | 1240 | 6.45 |
| | 3 | 1310 | 6.17 |
| 8 | 1 | 1250 | 5.77 |
| | 2 | 1140 | 6.28 |
| | 3 | 1130 | 6.32 |
| 8 | 1 | 1100 | 6.37 |
| | 2 | 1210 | 5.91 |
| | 3 | 1270 | 5.96 |
| 9 | 1 | 1050 | 6.49 |
| | 2 | 1080 | 6.26 |
| | 3 | 1140 | 6.12 |
| 10 | 1 | 1400 | 5.70 |
| | 2 | 1370 | 5.67 |
| | 3 | 1380 | 5.68 |
| 11 | 1 | 1480 | 5.70 |
| | 2 | 1430 | 5.73 |
| | 3 | 1550 | 5.47 |
| 11 | 1 | 1460 | 5.57 |
| | 2 | 1390 | 5.77 |
| | 3 | 1400 | 5.72 |
| 12 | 1 | 2020 | 4.84 |
| | 2 | 1870 | 5.02 |
| | 3 | 2600 | 3.77 |
| 13 | 1 | 1270 | 6.27 |
| | 2 | 1220 | 6.24 |
| | 3 | 1330 | 6.07 |
| 13 | 1 | 1250 | 5.90 |
| | 2 | 1340 | 6.13 |
| | 3 | 1230 | 6.16 |
| 14 | 1 | 1090 | 5.83 |
| | 2 | 1080 | 5.99 |
| | 3 | 965 | 6.36 |
| 15 | 1 | 1220 | 5.83 |
| | 2 | 1160 | 6.23 |
| | 3 | 1300 | 5.95 |
| 16 | 1 | 1160 | 5.44 |
| | 2 | 1200 | 5.54 |
| | 3 | 1170 | 5.67 |
| 17 | 1 | 1280 | 5.65 |
| | 2 | 1270 | 5.85 |
| | 3 | 1220 | 5.98 |
| 18 | 1 | 1270 | 5.87 |
| | 2 | 1310 | 5.78 |
| | 3 | 1150 | 5.96 |
| 19 | 1 | 1280 | 5.95 |
| | 2 | 1300 | 6.07 |
| | 3 | 1350 | 5.92 |
| 20 | 1 | 1050 | 6.18 |
| | 2 | 994 | 6.30 |
| | 3 | 1050 | 6.08 |
| 21 | 1 | 1410 | 6.22 |
| | 2 | 1410 | 6.22 |
| | 3 | 1510 | 5.89 |
| 22 | 1 | 1370 | 6.49 |
| | 2 | 1390 | 6.61 |
| | 3 | 1510 | 6.19 |
| 23 | 1 | 1270 | 6.35 |
| | 2 | 1140 | 6.87 |
| | 3 | 1290 | 6.29 |
| 24 | 1 | 1320 | 5.53 |
| | 2 | 1260 | 5.66 |
| | 3 | 1180 | 6.27 |
| 25 | 1 | 1150 | 6.21 |
| | 2 | 1210 | 6.21 |
| | 3 | 1160 | 6.27 |
| 26 | 1 | 1140 | 6.31 |
| | 2 | 1100 | 6.48 |
| | 3 | 1120 | 6.54 |
| 27 | 1 | 1110 | 6.15 |
| | 2 | 1100 | 6.39 |
| | 3 | 1090 | 6.57 |
| 28 | 1 | 1430 | 5.86 |
| | 2 | 1310 | 5.74 |
| | 3 | 1250 | 6.69 |
| 29 | 1 | 1320 | 6.04 |
| | 2 | 1300 | 6.10 |
| | 3 | 1380 | 5.86 |
| 30 | 1 | 1560 | 4.64 |
| | 2 | 1480 | 4.85 |
| | 3 | 1600 | 4.59 |
| A | 1 | 1380 | 7.75 |
| | 2 | 1380 | 7.81 |
| | 3 | 1200 | 8.26 |

### Example 7

### Optics of Films 1-6, 8, 11, 13, and 23-30

The optics (transparency, gloss, and haze) of Films 1-6, 8, 11, 13, and 23-30 was tested. Clarity of each sample was tested in accordance with ASTM D-1746. Gloss is a measure of the relative luster of the film surface and was determined in accordance with ASTM D-2457. Haze indicates the degree to which a film has reduced clarity or cloudiness and was determined in accordance with ASTM D-1003. The results of the optics testing are given below in Table 8.

TABLE 8
Optics Testing of Films 1-6, 8, 11, 13, and 23-30

| | | Clarity | | Haze | Thickness |
|---|---|---|---|---|---|
| Film | Rep. | (%) | Gloss | (%) | (mil) |
| 1 | 1 | 1.8 | 61 | 13.4 | 6.18 |
| | 2 | 2.2 | 62 | 13.8 | 6.31 |
| | 3 | 2.1 | 62 | 13.6 | 6.06 |
| | 4 | 2.5 | 62 | 14.1 | 6.18 |
| | Avg. | 2.2 | 62 | 13.7 | 6.18 |
| | Std. Dev. | 0.3 | 1.0 | 0.3 | 0.10 |
| 2 | 1 | 0.7 | 69 | 16.9 | 5.97 |
| | 2 | 0.5 | 64 | 22.9 | 8.81 |
| | 3 | 0.7 | 60 | 18.3 | 7.47 |
| | 4 | 0.9 | 67 | 14.3 | 5.53 |
| | Avg. | .07 | 65 | 18.1 | 6.95 |
| | Std. Dev. | 0.2 | 4.0 | 3.6 | 1.50 |
| 3 | 1 | 1.2 | 63 | 10.0 | 6.27 |
| | 2 | 1.1 | 64 | 9.3 | 5.94 |
| | 3 | 1.5 | 64 | 7.8 | 5.51 |
| | 4 | 1.4 | 65 | 8.5 | 5.88 |
| | Avg. | 1.3 | 64 | 8.9 | 5.90 |
| | Std. Dev. | 0.2 | 1.0 | 1.0 | 0.31 |
| 4 | 1 | 1.1 | 64 | 12.6 | 6.55 |
| | 2 | 1.2 | 65 | 10.7 | 5.96 |
| | 3 | 1.4 | 65 | 11.0 | 6.33 |
| | 4 | 1.5 | 64 | 11.2 | 6.22 |
| | Avg. | 1.3 | 65 | 11.4 | 6.27 |
| | Std. Dev. | 0.2 | 1.0 | 0.8 | 0.25 |
| 5 | 1 | 1.1 | 61 | 15.1 | 6.49 |
| | 2 | 1.9 | 61 | 13.2 | 6.07 |
| | 3 | 1.8 | 62 | 12.8 | 6.11 |
| | 4 | 1.2 | 61 | 15.0 | 6.82 |
| | Avg. | 1.5 | 61 | 14.0 | 6.37 |
| | Std. Dev. | 0.4 | 1.0 | 1.2 | 0.35 |
| 6 | 1 | 1.7 | 64 | 10.9 | 6.49 |
| | 2 | 1.2 | 63 | 11.8 | 6.45 |
| | 3 | 1.3 | 64 | 11.6 | 6.33 |
| | 4 | 1.8 | 63 | 10.6 | 6.24 |
| | Avg. | 1.5 | 64 | 11.2 | 6.38 |
| | Std. Dev. | 0.3 | 1.0 | 0.6 | 0.11 |
| 6 | 1 | 2.1 | 63 | 10.7 | 6.20 |
| | 2 | 2.1 | 65 | 10.8 | 6.04 |
| | 3 | 1.8 | 63 | 11.3 | 6.67 |
| | 4 | 2.5 | 62 | 10.6 | 5.94 |
| | Avg. | 2.1 | 63 | 10.9 | 6.21 |
| | Std. Dev. | 0.3 | 1.0 | 0.3 | 0.32 |
| 8 | 1 | 0.8 | 21.0 | 94.5 | 6.14 |
| | 2 | 0.7 | 24.0 | 94.4 | 6.12 |
| | 3 | 0.6 | 21.7 | 94.5 | 6.04 |
| | 4 | 1.1 | 21.4 | 94.6 | 5.60 |
| | Avg. | 0.8 | 22.0 | 94.5 | 5.98 |
| | Std. Dev. | 0.2 | 1.3 | 0.1 | 0.25 |
| 11 | 1 | 0.8 | 18.2 | 94.4 | 5.62 |
| | 2 | 1.1 | 17.8 | 94.4 | 5.90 |
| | 3 | 0.7 | 19.6 | 94.4 | 5.68 |
| | 4 | 1.0 | 18.7 | 94.4 | 5.56 |
| | Avg. | 0.9 | 18.6 | 94.4 | 5.69 |
| | Std. Dev. | 0.2 | 0.8 | 0.0 | 0.15 |
| 13 | 1 | 0.9 | 17.3 | 94.7 | 6.26 |
| | 2 | 0.6 | 16.8 | 94.6 | 6.20 |
| | 3 | 0.8 | 16.5 | 94.7 | 6.16 |
| | 4 | 1.1 | 16.4 | 94.7 | 6.18 |
| | Avg. | 0.9 | 16.8 | 94.7 | 6.20 |
| | Std. Dev. | 0.2 | 0.4 | 0.1 | 0.04 |
| 23 | 1 | 0.8 | 18.3 | 93.9 | 7.14 |
| | 2 | 1.0 | 17.3 | 94.7 | 5.92 |
| | 3 | 1.3 | 16.4 | 94.7 | 6.10 |
| | 4 | 0.6 | 16.7 | 94.8 | 5.366 |
| | Avg. | 0.9 | 17.2 | 94.5 | 6.13 |
| | Std. Dev. | 0.3 | 0.8 | 0.4 | 0.74 |
| 24 | 1 | 1.3 | 19.8 | 94.8 | 5.58 |
| | 2 | 0.7 | 18.0 | 94.8 | 6.42 |
| | 3 | 1.0 | 20.6 | 94.8 | 5.54 |
| | 4 | 0.8 | 18.9 | 94.8 | 6.34 |
| | Avg. | 1.0 | 19.3 | 94.8 | 5.97 |
| | Std. Dev. | 0.3 | 1.1 | 0.0 | 0.47 |
| 25 | 1 | 0.7 | 19.5 | 94.7 | 5.86 |
| | 2 | 0.6 | 19.7 | 94.7 | 6.32 |
| | 3 | 0.8 | 19.0 | 94.7 | 6.44 |
| | 4 | 0.7 | 21.2 | 94.8 | 6.24 |
| | Avg. | 0.7 | 19.9 | 94.7 | 6.22 |
| | Std. Dev. | 0.1 | 0.9 | 0.1 | 0.25 |
| 26 | 1 | 6.5 | 6.7 | 94.7 | 6.86 |
| | 2 | 8.2 | 7.7 | 94.8 | 6.28 |
| | 3 | 5.8 | 10.7 | 94.7 | 6.30 |
| | 4 | 6.9 | 7.9 | 94.7 | 6.30 |
| | Avg. | 6.9 | 8.3 | 94.7 | 6.44 |
| | Std. Dev. | 1.0 | 1.7 | 0.1 | 0.28 |
| 27 | 1 | 3.7 | 9.2 | 94.7 | 6.68 |
| | 2 | 2.7 | 9.9 | 94.7 | 6.46 |
| | 3 | 3.9 | 12.1 | 94.7 | 6.24 |
| | 4 | 2.6 | 12.2 | 94.5 | 6.54 |
| | Avg. | 3.2 | 10.9 | 94.7 | 6.48 |
| | Std. Dev. | 0.7 | 1.5 | 0.1 | 0.18 |
| 28 | 1 | 0.8 | 18.5 | 94.6 | 6.08 |
| | 2 | 0.5 | 18.7 | 94.6 | 6.34 |
| | 3 | 0.7 | 19.7 | 94.4 | 6.20 |
| | 4 | 1.0 | 18.5 | 94.5 | 6.28 |
| | Avg. | 0.8 | 18.9 | 94.5 | 6.23 |
| | Std. Dev. | 0.2 | 0.6 | 0.1 | 0.11 |
| 29 | 1 | 1.2 | 19.0 | 94.7 | 6.30 |
| | 2 | 0.8 | 19.2 | 94.7 | 5.94 |
| | 3 | 0.5 | 18.3 | 94.7 | 6.14 |
| | 4 | 0.8 | 18.2 | 94.7 | 5.90 |
| | Avg. | 0.80 | 18.7 | 94.7 | 6.07 |
| | Std. Dev. | 0.5 | 0.5 | 0.0 | 0.19 |
| 30 | 1 | 1.0 | 14.1 | 94.0 | 6.20 |
| | 2 | 0.9 | 15.2 | 93.9 | 7.00 |
| | 3 | 1.0 | 16.3 | 93.7 | 7.58 |
| | 4 | 1.0 | 14.4 | 93.9 | 6.94 |
| | Avg. | 1.0 | 15.0 | 93.9 | 6.93 |
| | Std. Dev. | 0.1 | 1.0 | 0.1 | 0.57 |

### Example 8

### Individual Bag Drop Testing

Films 31-51 were crosslinked at 71 (labeled with an “a”) or 100 kGy (labeled with a “b”) and formed into bags having a lay-flat width of about 4½×11 inches. Each bag contained about 1 liter of water. The sealing temperature to produce the bags was about 280° F. Individual bag drop tests were conducted using a modified version of ISO 15747 to determine the amount of abuse an individual bag can be expected to withstand. The modified test version was conducted using 1½ to 2 times the height requirement for IV bags and required 6 drops.

To conduct the test, each bag was held flat (with the end seals out) and dropped by hand at a height or 1.5 meters or 2 meters, as set forth in Table 9 below. The height and number of the drop was recorded. If the bag withstood the drop (i.e., it did not burst or leak), it passed the test and was determined to have “survived” the test. If the bag ruptured or leaked, it was determined to have not survived the test.

TABLE 9
Drop Testing of Films 131-51

| | Drop | | | | |
|---|---|---|---|---|---|
| Film | Height | Temp | # bags | # bags | % |
| ID | (meters) | (° C.) | survived | failed | survival |
| 33^{a} | 1.5 | 130 | 5 | 0 | 100 |
| | | 140 | 5 | 0 | 100 |
| | | 150 | 5 | 0 | 100 |
| | | Total | 15 | 0 | 100 |
| | 2.0 | 130 | 5 | 0 | 100 |
| | | 140 | 4 | 1 | 80 |
| | | 150 | 5 | 0 | 100 |
| | | Total | 14 | 1 | 93.3 |
| 33^{b} | 1.5 | 130 | 5 | 0 | 100 |
| | | 140 | n/a | n/a | n/a |
| | | 150 | 5 | 0 | 100 |
| | | Total | 10 | 0 | 100 |
| | 2.0 | 130 | 4 | 1 | 80 |
| | | 140 | n/a | n/a | n/a |
| | | 150 | 5 | 0 | 100 |
| | | Total | 9 | 1 | 90 |
| 34^{a} | 1.5 | 130 | 5 | 0 | 100 |
| | | 140 | 5 | 0 | 100 |
| | | 150 | 5 | 0 | 100 |
| | | Total | 15 | 0 | 100 |
| | 2.0 | 130 | 4 | 1 | 80 |
| | | 140 | 4 | 1 | 80 |
| | | 150 | 2 | 3 | 40 |
| | | Total | 10 | 5 | 66.7 |
| 34^{b} | 1.5 | 130 | 4 | 1 | 80 |
| | | 140 | 5 | 0 | 100 |
| | | 150 | 5 | 0 | 100 |
| | | Total | 14 | 1 | 93.3 |
| | 2.0 | 130 | 3 | 2 | 60 |
| | | 140 | 5 | 0 | 100 |
| | | 150 | 4 | 1 | 80 |
| | | Total | 12 | 3 | 80 |
| 35^{a} | 1.5 | 130 | 5 | 0 | 100 |
| | | 140 | n/a | n/a | n/a |
| | | 150 | 5 | 0 | 100 |
| | | Total | 10 | 0 | 100 |
| | 2.0 | 130 | 5 | 0 | 100 |
| | | 140 | n/a | n/a | n/a |
| | | 150 | 5 | 0 | 100 |
| | | Total | 10 | 0 | 100 |
| 35^{b} | 1.5 | 130 | 5 | 0 | 100 |
| | | 140 | n/a | n/a | n/a |
| | | 150 | 5 | 0 | 100 |
| | | Total | 10 | 0 | 100 |
| | 2.0 | 130 | 5 | 0 | 100 |
| | | 140 | n/a | n/a | n/a |
| | | 150 | 5 | 0 | 100 |
| | | Total | 10 | 0 | 100 |
| 31^{a} | 1.5 | 130 | 3 | 2 | 60 |
| | | 140 | 5 | 0 | 100 |
| | | 150 | 5 | 0 | 100 |
| | | Total | 13 | 2 | 86.7 |
| | 2.0 | 130 | 1 | 4 | 20 |
| | | 140 | 4 | 1 | 80 |
| | | 150 | 3 | 2 | 60 |
| | | Total | 8 | 7 | 53.3 |
| 31^{b} | 1.5 | 130 | 5 | 0 | 100 |
| | | 140 | n/a | n/a | n/a |
| | | 150 | 5 | 0 | 100 |
| | | Total | 10 | 0 | 100 |
| | 2.0 | 130 | 4 | 1 | 80 |
| | | 140 | n/a | n/a | n/a |
| | | 150 | 5 | 0 | 100 |
| | | Total | 9 | 1 | 90 |
| 32^{a} | 1.5 | 130 | 4 | 1 | 80 |
| | | 140 | 3 | 2 | 60 |
| | | 150 | 4 | 1 | 80 |
| | | Total | 11 | 4 | 73.3 |
| | 2.0 | 130 | 3 | 2 | 60 |
| | | 140 | 1 | 4 | 20 |
| | | 150 | 1 | 4 | 20 |
| | | Total | 5 | 10 | 33.3 |
| 32^{b} | 1.5 | 130 | 5 | 0 | 100 |
| | | 140 | 5 | 0 | 100 |
| | | 150 | 4 | 1 | 80 |
| | | Total | 14 | 1 | 93.3 |
| | 2.0 | 130 | 4 | 1 | 80 |
| | | 140 | 3 | 2 | 60 |
| | | 150 | 3 | 2 | 60 |
| | | Total | 10 | 5 | 66.7 |
| 36^{a} | 1.5 | 130 | 4 | 1 | 80 |
| | | 140 | 5 | 0 | 100 |
| | | 150 | 4 | 1 | 80 |
| | | Total | 13 | 2 | 86.7 |
| | 2.0 | 130 | 3 | 2 | 60 |
| | | 140 | 3 | 2 | 60 |
| | | 150 | 4 | 1 | 80 |
| | | Total | 10 | 5 | 66.7 |
| 36^{b} | 1.5 | 130 | 5 | 0 | 100 |
| | | 140 | 5 | 0 | 100 |
| | | 150 | 5 | 0 | 100 |
| | | Total | 15 | 0 | 100 |
| | 2.0 | 130 | 3 | 2 | 60 |
| | | 140 | 2 | 3 | 40 |
| | | 150 | 3 | 2 | 60 |
| | | Total | 8 | 7 | 53.3 |
| 37^{a} | 1.5 | 130 | 5 | 0 | 100 |
| | | 140 | 5 | 0 | 100 |
| | | 150 | 5 | 0 | 100 |
| | | Total | 15 | 0 | 100 |
| | 2.0 | 130 | 4 | 1 | 80 |
| | | 140 | 4 | 1 | 80 |
| | | 150 | 3 | 2 | 60 |
| | | Total | 11 | 4 | 73.3 |
| 37^{b} | 1.5 | 130 | 5 | 0 | 100 |
| | | 140 | 5 | 0 | 100 |
| | | 150 | 5 | 0 | 100 |
| | | Total | 15 | 0 | 100 |
| | 2.0 | 130 | 3 | 2 | 60 |
| | | 140 | 2 | 3 | 40 |
| | | 150 | 4 | 1 | 80 |
| | | Total | 9 | 6 | 60 |
| 38^{a} | 1.5 | 130 | 5 | 0 | 100 |
| | | 140 | 5 | 0 | 100 |
| | | 150 | 5 | 0 | 100 |
| | | Total | 15 | 0 | 100 |
| | 2.0 | 130 | 5 | 0 | 100 |
| | | 140 | 5 | 0 | 100 |
| | | 150 | 1 | 4 | 20 |
| | | Total | 11 | 4 | 73.3 |
| 38^{b} | 1.5 | 130 | 5 | 0 | 100 |
| | | 140 | 5 | 0 | 100 |
| | | 150 | 5 | 0 | 100 |
| | | Total | 15 | 0 | 100 |
| | 2.0 | 130 | 1 | 4 | 20 |
| | | 140 | 3 | 2 | 60 |
| | | 150 | 2 | 3 | 40 |
| | | Total | 6 | 9 | 40 |
| 39^{a} | 1.5 | 130 | 4 | 1 | 80 |
| | | 140 | n/a | n/a | n/a |
| | | 150 | 5 | 0 | 100 |
| | | Total | 9 | 1 | 90 |
| | 2.0 | 130 | 4 | 1 | 80 |
| | | 140 | n/a | n/a | n/a |
| | | 150 | 5 | 0 | 100 |
| | | Total | 9 | 1 | 90 |
| 39^{b} | 1.5 | 130 | 5 | 0 | 100 |
| | | 140 | 5 | 0 | 100 |
| | | 150 | 5 | 0 | 100 |
| | | Total | 15 | 0 | 100 |
| | 2.0 | 130 | 2 | 3 | 40 |
| | | 140 | 4 | 1 | 80 |
| | | 150 | 2 | 3 | 40 |
| | | Total | 8 | 7 | 53.3 |
| 40^{a} | 1.5 | 130 | 5 | 0 | 100 |
| | | 140 | n/a | n/a | n/a |
| | | 150 | 5 | 0 | 100 |
| | | Total | 10 | 0 | 100 |
| | 2.0 | 130 | 5 | 0 | 100 |
| | | 140 | n/a | n/a | n/a |
| | | 150 | 4 | 1 | 80 |
| | | Total | 9 | 1 | 90 |
| 40^{b} | 1.5 | 130 | 5 | 0 | 100 |
| | | 140 | 5 | 0 | 100 |
| | | 150 | 3 | 0 | 100 |
| | | Total | 13 | 0 | 100 |
| | 2.0 | 130 | 2 | 3 | 40 |
| | | 140 | 2 | 3 | 40 |
| | | 150 | 3 | 2 | 60 |
| | | Total | 7 | 8 | 53.85 |
| 41^{a} | 1.5 | 130 | 5 | 0 | 100 |
| | | 140 | 5 | 0 | 100 |
| | | 150 | 4 | 1 | 80 |
| | | Total | 14 | 1 | 93.3 |
| | 2.0 | 130 | 3 | 2 | 60 |
| | | 140 | 1 | 4 | 20 |
| | | 150 | 1 | 4 | 20 |
| | | Total | 5 | 10 | 33.3 |
| 41^{b} | 1.5 | 130 | 5 | 0 | 100 |
| | | 140 | 5 | 0 | 100 |
| | | 150 | 5 | 0 | 100 |
| | | Total | 15 | 0 | 100 |
| | 2.0 | 130 | 1 | 4 | 20 |
| | | 140 | 2 | 3 | 40 |
| | | 150 | 2 | 3 | 40 |
| | | Total | 5 | 10 | 33.3 |
| 42^{a} | 1.5 | 130 | 5 | 0 | 100 |
| | | 140 | 4 | 1 | 80 |
| | | 150 | 5 | 0 | 100 |
| | | Total | 14 | 1 | 93.3 |
| | 2.0 | 130 | 2 | 3 | 40 |
| | | 140 | 0 | 5 | 0 |
| | | 150 | 2 | 3 | 40 |
| | | Total | 4 | 11 | 26.7 |
| 42^{b} | 1.5 | 130 | 5 | 0 | 100 |
| | | 140 | 4 | 0 | 100 |
| | | 150 | 5 | 0 | 100 |
| | | Total | 14 | 1 | 100 |
| | 2.0 | 130 | 2 | 3 | 40 |
| | | 140 | 3 | 2 | 60 |
| | | 150 | 2 | 2 | 50 |
| | | Total | 7 | 7 | 50 |
| 43^{a} | 1.5 | 130 | 5 | 0 | 100 |
| | | 140 | 2 | 3 | 40 |
| | | 150 | 5 | 0 | 100 |
| | | Total | 12 | 3 | 80 |
| | 2.0 | 130 | 4 | 1 | 80 |
| | | 140 | 1 | 4 | 20 |
| | | 150 | 0 | 5 | 0 |
| | | Total | 5 | 10 | 33.3 |
| 43^{b} | 1.5 | 130 | 5 | 0 | 100 |
| | | 140 | 5 | 0 | 100 |
| | | 150 | 3 | 2 | 60 |
| | | Total | 13 | 2 | 86.7 |
| | 2.0 | 130 | 5 | 0 | 100 |
| | | 140 | 5 | 0 | 100 |
| | | 150 | 3 | 2 | 60 |
| | | Total | 13 | 2 | 86.7 |
| 44^{a} | 1.5 | 130 | 5 | 0 | 100 |
| | | 140 | 4 | 1 | 80 |
| | | 150 | 5 | 0 | 100 |
| | | Total | 14 | 1 | 93.3 |
| | 2.0 | 130 | 1 | 4 | 20 |
| | | 140 | 1 | 4 | 20 |
| | | 150 | 3 | 2 | 60 |
| | | Total | 5 | 10 | 33.3 |
| 44^{b} | 1.5 | 130 | 4 | 1 | 80 |
| | | 140 | 5 | 0 | 100 |
| | | 150 | 5 | 0 | 100 |
| | | Total | 14 | 1 | 93.3 |
| | 2.0 | 130 | 1 | 4 | 20 |
| | | 140 | 3 | 2 | 60 |
| | | 150 | 3 | 2 | 60 |
| | | Total | 7 | 8 | 46.7 |
| 45^{a} | 1.5 | 130 | 5 | 0 | 100 |
| | | 140 | 5 | 0 | 100 |
| | | 150 | 4 | 1 | 80 |
| | | Total | 14 | 1 | 93.3 |
| | 2.0 | 130 | 1 | 4 | 20 |
| | | 140 | 3 | 2 | 60 |
| | | 150 | 0 | 5 | 0 |
| | | Total | 4 | 11 | 26.7 |
| 45^{b} | 1.5 | 130 | 5 | 0 | 100 |
| | | 140 | 5 | 0 | 100 |
| | | 150 | 5 | 0 | 100 |
| | | Total | 15 | 0 | 100 |
| | 2.0 | 130 | 2 | 3 | 40 |
| | | 140 | 0 | 5 | 100 |
| | | 150 | 1 | 4 | 20 |
| | | Total | 3 | 12 | 20 |
| 46^{a} | 1.5 | 130 | 5 | 0 | 100 |
| | | 140 | 5 | 0 | 100 |
| | | 150 | 4 | 1 | 80 |
| | | Total | 14 | 1 | 93.3 |
| | 2.0 | 130 | 2 | 3 | 40 |
| | | 140 | 2 | 3 | 40 |
| | | 150 | 2 | 3 | 40 |
| | | Total | 6 | 9 | 40 |
| 46^{b} | 1.5 | 130 | 5 | 0 | 100 |
| | | 140 | 5 | 0 | 100 |
| | | 150 | 5 | 0 | 100 |
| | | Total | 15 | 0 | 100 |
| | 2.0 | 130 | 2 | 3 | 40 |
| | | 140 | 4 | 1 | 80 |
| | | 150 | 4 | 1 | 80 |
| | | Total | 10 | 5 | 66.7 |
| 47^{a} | 1.5 | 130 | 5 | 0 | 100 |
| | | 140 | 5 | 0 | 100 |
| | | 150 | 5 | 0 | 100 |
| | | Total | 15 | 0 | 100 |
| | 2.0 | 130 | 3 | 2 | 60 |
| | | 140 | 2 | 3 | 40 |
| | | 150 | 2 | 3 | 40 |
| | | Total | 7 | 8 | 46.7 |
| 47^{b} | 1.5 | 130 | 5 | 0 | 100 |
| | | 140 | 5 | 0 | 100 |
| | | 150 | 5 | 0 | 100 |
| | | Total | 15 | 0 | 100 |
| | 2.0 | 130 | 2 | 3 | 40 |
| | | 140 | 4 | 1 | 80 |
| | | 150 | 2 | 3 | 40 |
| | | Total | 8 | 7 | 53.3 |
| 48^{a} | 1.5 | 130 | 5 | 0 | 100 |
| | | 140 | 5 | 0 | 100 |
| | | 150 | 4 | 1 | 80 |
| | | Total | 14 | 1 | 93.3 |
| | 2.0 | 130 | 4 | 1 | 80 |
| | | 140 | 1 | 4 | 20 |
| | | 150 | 2 | 3 | 40 |
| | | Total | 7 | 8 | 46.7 |
| 48^{b} | 1.5 | 130 | 5 | 0 | 100 |
| | | 140 | 5 | 0 | 100 |
| | | 150 | 5 | 0 | 100 |
| | | Total | 15 | 0 | 100 |
| | 2.0 | 130 | 3 | 2 | 60 |
| | | 140 | 4 | 1 | 80 |
| | | 150 | 4 | 1 | 80 |
| | | Total | 11 | 4 | 73.3 |
| 49^{a} | 1.5 | 130 | 5 | 0 | 100 |
| | | 140 | 5 | 0 | 100 |
| | | 150 | 4 | 1 | 80 |
| | | Total | 14 | 1 | 93.3 |
| | 2.0 | 130 | 4 | 1 | 80 |
| | | 140 | 2 | 3 | 40 |
| | | 150 | 2 | 2 | 40 |
| | | Total | 8 | 7 | 73.3 |
| 49^{b} | 1.5 | 130 | 5 | 0 | 100 |
| | | 140 | 4 | 1 | 80 |
| | | 150 | 5 | 0 | 100 |
| | | Total | 14 | 1 | 93.3 |
| | 2.0 | 130 | 3 | 2 | 60 |
| | | 140 | 3 | 2 | 60 |
| | | 150 | 4 | 1 | 80 |
| | | Total | 10 | 5 | 66.7 |
| 51^{a} | 1.5 | 130 | 3 | 2 | 60 |
| | | 140 | 5 | 0 | 100 |
| | | 150 | 5 | 0 | 100 |
| | | Total | 13 | 2 | 86.7 |
| | 2.0 | 130 | 3 | 2 | 60 |
| | | 140 | 3 | 2 | 60 |
| | | 150 | 4 | 1 | 80 |
| | | Total | 10 | 5 | 66.7 |
| 50^{a} | 1.5 | 130 | 3 | 2 | 60 |
| | | 140 | 1 | 4 | 20 |
| | | 150 | 4 | 1 | 80 |
| | | Total | 8 | 7 | 53.3 |
| | 2.0 | 130 | 0 | 5 | 0 |
| | | 140 | 0 | 5 | 0 |
| | | 150 | 0 | 5 | 0 |
| | | Total | 0 | 15 | 0 |
| 50^{b} | 1.5 | 130 | 4 | 1 | 80 |
| | | 140 | 2 | 3 | 40 |
| | | 150 | 4 | 1 | 80 |
| | | Total | 10 | 5 | 66.7 |
| | 2.0 | 130 | 0 | 5 | 0 |
| | | 140 | 0 | 5 | 0 |
| | | 150 | 0 | 5 | 0 |
| | | Total | 0 | 15 | 0 |

^{a}= crosslinked at 71 kGy
^{b}= crosslinked at 100 kGy

### CONCLUSIONS

The information presented in the foregoing examples demonstrates that through novel selection and application of polyolefin resins, a majority polyolefin film can be constructed to meet the criteria of an IV Pharmaceutical bag. In addition, the disclosed film (at a 20-25% less weight/thickness) can be constructed to meet and exceed all use criteria, whereas current films must be thicker to meet the use criteria. The disclosed film is based on a majority of metallocene catalyzed polymers has less extractables compared to films that employ non-metallocene catalyzed polymers, which will impart added safety of the use of the disclosed film in a wide variety of applications, such as IV pouches.

What is claimed is:

1. A multilayer film comprising:
a. a first outer layer comprising about 100% by weight polyolefin, based on the total weight of the layer;
b. a core layer comprising about 100% by weight polyolefin, based on the total weight of the layer; and
c. a second outer layer comprising about 100% by weight polyolefin, based on the total weight of the layer.

2. The film of claim 1, wherein said polyolefin is a material selected from the group comprising: polyethylene homopolymers, polypropylene homopolymers, polybutene homopolymers, ethylene alpha olefin copolymer, propylene alpha olefin copolymer, butene alpha olefin copolymer, ethylene unsaturated ester copolymer, ethylene unsaturated acid copolymer, ethylene vinyl acetate copolymer, ionomer resin, polymethylpentene, and combinations thereof.

3. The film of claim 1, wherein said film comprises at least one intermediate layer comprising about 100% by weight polyolefin, based on the total weight of the layer.

4. The film of claim 1, wherein said film comprises a tensile elongation at yield of about 10% to about 30%, in accordance with ASTM D-882.

5. The film of claim 1, wherein said film comprises a tensile elongation at break of about 500% to about 700%, in accordance with ASTM D-882.

6. The film of claim 1, wherein said film comprises a Young's modulus of about 25,000 psi to about 55,000 psi, in accordance with ASTM D-638.

7. The film of claim 1, wherein said film comprises a moisture vapor transmission rate of about 0.1 to about 0.3 g/100 in²-day, in accordance with ASTM F-1249.

8. The film of claim 1, wherein said film comprises an oxygen transmission rate of about 900 to about 3,000 cc/m²-day-atm, in accordance with ASTM D-3985.

9. The film of claim 1, wherein said film comprises an instrumented impact in the range of about 2.5 to about 15.0 J/mil, in accordance with ASTM D-3763.

10. The film of claim 1, wherein said film is crosslinked.

11. The film of claim 1, wherein said film has a thickness ranging from about 3 mils to about 8 mils.

12. A pouch for the packaging and administration of a product, said pouch comprising a multilayer film comprising:
a. a first outer layer comprising about 100% by weight polyolefin, based on the total weight of the layer;
b. a core layer comprising about 100% by weight polyolefin, based on the total weight of the layer; and
c. a second outer layer comprising about 100% by weight polyolefin, based on the total weight of the layer.

13. The pouch of claim 12, wherein said product comprises a medical product.

14. The pouch of claim 12, wherein said film comprises at least one intermediate layer comprising about 100% by weight polyolefin, based on the total weight of the layer.

15. The pouch of claim 12, wherein said film comprises a tensile elongation at yield of about 10% to about 30%, in accordance with ASTM D-882.

16. The pouch of claim 12, wherein said film comprises a tensile elongation at break of about 500% to about 700%, in accordance with ASTM D-882.

17. The pouch of claim 12, wherein said film comprises a Young's modulus of about 25,000 psi to about 55,000 psi, in accordance with ASTM D-638.

18. The pouch of claim 12, wherein said film comprises a moisture vapor transmission rate of about 0.1 to about 0.3 g/100 in²-day, in accordance with ASTM F-1249.

19. The pouch of claim 12, wherein said film comprises an oxygen transmission rate of about 900 to about 3,000 cc/m²-day-atm, in accordance with ASTM D-3985.

20. The pouch of claim 12, wherein said film comprises an instrumented impact in the range of about 2.5 to about 15.0 J/mil, in accordance with ASTM D-3763.

21. The pouch of claim 12, wherein said film is crosslinked.

22. The pouch of claim 12, wherein said film has a thickness ranging from about 3 mils to about 8 mils.

23. A method of packaging a product in a pouch, said method comprising:
a. providing a pouch, said pouch comprising a film comprising:
i. a first outer layer comprising about 100% by weight polyolefin, based on the total weight of the layer;
ii. a core layer comprising about 100% by weight polyolefin, based on the total weight of the layer; and
iii. a second outer layer comprising about 100% by weight polyolefin, based on the total weight of the layer.
b. placing a product into the interior of said pouch; and
c. sealing said pouch.

24. The method of claim 23, wherein said product comprises a medical product.

25. The method of claim 23, wherein said film comprises at least one intermediate layer comprising about 100% by weight polyolefin, based on the total weight of the layer.

26. The method of claim 23, wherein said film comprises a tensile elongation at yield of about 10% to about 30%, in accordance with ASTM D-882.

27. The method of claim 23, wherein said film comprises a tensile elongation at break of about 500% to about 700%, in accordance with ASTM D-882.

28. The method of claim 23, wherein said film comprises a Young's modulus of about 25,000 psi to about 55,000 psi, in accordance with ASTM D-638.

29. The method of claim 23, wherein said film comprises a moisture vapor transmission rate of about 0.1 to about 0.3 g/100 in²-day, in accordance with ASTM F-1249.

30. The method of claim 23, wherein said film comprises an oxygen transmission rate of about 900 to about 3,000 cc/m²-day-atm, in accordance with ASTM D-3985.

31. The method of claim 23, wherein said film comprises an instrumented impact in the range of about 2.5 to about 15.0 J/mil, in accordance with ASTM D-3763.

32. The method of claim 23, wherein said film is crosslinked.

33. The method of claim 23, wherein said film has a thickness ranging from about 3 mils to about 8 mils.
